(19) United States
(12) Patent Application Publication
(10) Pub. No.: US 2005/0064240 A1
(43) Pub. Date: Mar. 24, 2005

(54) Organic electroluminescent device

(76) Inventors: Masayuki Mishima, Minami-Ashigara-shi (JP); Kazumi Nii, Minami-Ashigara-shi (JP); Tatsuya Igarashi, Minami-Ashigara-shi (JP)

Correspondence Address: BIRCH STEWART KOLASCH & BIRCH, PO BOX 747, FALLS CHURCH, VA, 22040-0747, US

(21) Appl. No.: 10/942,944

(22) Filed: Sep. 17, 2004

(30) Foreign Application Priority Data
Sep. 24, 2003 (JP) P. 2003-330995
Sep. 24, 2003 (JP) P. 2003-331516
Aug. 10, 2004 (JP) P. 2004-233037

(51) Int. Cl. H05B 33/12

(52) U.S. Cl. 428/690; 428/917; 428/212; 313/504; 313/506

(57) ABSTRACT

An organic electroluminescent device comprising a pair of electrodes and at least one organic layer including a light-emitting layer between the pair of electrodes, wherein the light-emitting layer contains a hole-transporting material, an electron-transporting material and a luminescent material; and an ionization potential of the hole-transporting material, Ip (HL), an ionization potential of the electron-transporting material, Ip (EL), and an ionization potential of the luminescent material, Ip (L) satisfy the relationship: Ip (L)≦IP (HL)≦Ip (EL).

### FIELD OF THE INVENTION

This invention relates to an organic electroluminescent device which is highly excellent in durability and has an extremely high luminance and an extremely high luminescence efficiency.

### BACKGROUND OF THE INVENTION

Organic electroluminescent devices using organic substances are promising candidates for application to inexpensive, solid-state, full-color, wide flat-panel displays or writing light source arrays for printers and, therefore, a great number of attempts have been made for developing the same. Organic electroluminescent devices are generally composed of a pair of opposing electrodes and an organic light-emitting layer located between these electrodes. Light emission (luminescence) is a phenomenon that, upon electric field application between the electrodes, electrons are injected from the cathode, and positive holes are injected from the anode, the injected electrons and holes are recombined in the light-emitting layer, and the energy level returns from the conduction band to the valence band while emitting energy as light output.

However, these organic electroluminescent devices suffer from a serious problem of being inferior in driving durability to organic LED devices and fluorescent tubes.

Deterioration of durability is caused by external factors such as an increase in dark spots and peeling in electrodes due to invasion of moisture and oxygen, as well as internal factors such as decomposition and crystallization of materials due to electrochemical oxidation-reduction and decomposition of host materials and luminescent materials starting from excitons thereof. Deterioration caused by the external factors can be avoided by improving a process for constructing devices or employing a blocking step or a blocking procedure. To overcome deterioration caused by the internal factors, on the other hands, studies have been made on various materials and device constitutions. For example, it is intended to achieve high durability via bipolarization by adding a hole-transporting material to thereby elevate the stability to holes of an electron-transporting host material (in particular, an aluminum quinoline complex) used in the light-emitting layer (see Applied Physics Letters, 1999, Vol.75, p.172). It is also attempted to bipolarize the light-emitting layer and improve durability by using a specific anthracene derivative as a hole-transporting compound (see JP-A-2001-284050). Furthermore, attempts are made to improve durability by defining the energy gap among a hole-transporting host material and an electron-transporting host material in the light-emitting layer and a luminescent material to facilitate energy transfer by excitons (see JP-A-2002-198183, JP-A-2002-260861 and U.S. Pat. No. 5,853,905).

Although the host materials employed in the light-emitting layer in the organic electroluminescent devices reported in the above documents show improved electrochemical stabilities, it is still impossible to prevent the decomposition of host materials and luminescent materials starting from excitons thereof, which restricts the improvement in durability. In each of the organic electroluminescent devices reported in the above documents, it appears that the energy transfer mechanism proceeds as follows. First, an energy gap in the light-emitting layer is defined as described above and thus excitons are formed in the host material in the light-emitting layer. Next, these host excitons are energy-transferred to the luminescent material and thus excitons are formed in the luminescent materials. To improve durability, therefore, it has been strongly required to develop a method by which not only the electrochemical stability of materials is improved but also excitons can be stabilized.

From another viewpoint, no consideration is made in the above documents for the charge carrier transport characteristics of charge carrier-transporting materials in the hole-transporting layer or the electron-transporting layer adjacent to the light-emitting layer. For example, it is observed in some cases that the hole-transporting material in the hole-transporting layer is the same as the hole-transporting material employed in the light-emitting layer, or the electron-transporting material in the electron-transporting layer is the same as the electron-transporting material employed in the light-emitting layer. Even in the case of using different materials, these materials have almost the same ionization potentials or electron affinities. As a result, there arises a problem of passing (leakage, leaching or penetration) of holes and electrons and thus the luminescence efficiency is lowered, which restricts the improvement in durability.

### SUMMARY OF THE INVENTION

An object of the invention is to provide an organic electroluminescent device being excellent in durability and having a high luminescence efficiency and a high luminance.

To achieve the above-described object, the inventors conducted intensive studies. As a result, they have found out that host materials and luminescent materials can be prevented from the decomposition starting from excitons thereof by using a hole-transporting material, an electron-transporting material and a luminescent material together in the light-emitting layer and controlling the ionization potentials thereof. The inventors have further found out that luminescence efficiency and durability can be improved by controlling the ionization potentials of charge carrier transporting and transferring materials in the light-emitting layer, the hole-transporting layer and the electron-transporting layer.

Accordingly, the above-described object of the invention can be achieved by an organic electroluminescent device as will be illustrated hereinafter.

According to the invention, the following light-emitting device is provided and thus the above-described object of the invention can be achieved.

<1> An organic electroluminescent device having organic layers comprising at least one light-emitting layer between a pair of electrodes,
wherein the light-emitting layer contains a hole-transporting material, an electron-transporting material and a luminescent material; and
the respective ionization potentials Ip (HL), Ip (EL) and Ip (L) of the hole-transporting material, the electron-transporting material and the luminescent material satisfy the following relationship:
   Ip (L)≦IP (HL)≦Ip (EL).

<2> The organic electroluminescent device as described in the above <1>,
wherein the respective electron affinities Ea (HL), Ea (EL) and Ea (L) of the hole-transporting material, the electron-transporting material and the luminescent material in the light-emitting layer satisfy the following relationship:
   Ea (L)≧Ea (EL)≧Ea (HL).

<3> An organic electroluminescent device having a hole-transporting layer, a light-emitting layer and an electron-transporting layer between a pair of electrodes,
wherein the light-emitting layer contains a hole-transporting material, an electron-transporting material and a luminescent material; and
the respective ionization potentials Ip (HH), Ip (HL), Ip (EL) and Ip (EE) of the hole-transporting material in the hole-transporting layer, the hole-transporting material in the light-emitting layer, the electron-transporting material in the light-emitting layer and the electron-transporting material in the electron-transporting layer satisfy the following relationship:
   Ip (HH)≦IP (HL)≦Ip (EL)≦Ip (EE).

<4> The organic electroluminescent device as described in the above <3>,
wherein the ionization potential (Ip (EL)) of the electron-transporting material in the light-emitting layer and the ionization potential (Ip (EE)) of the electron-transporting material in the electron-transporting layer satisfy the following relationship:
   Ip (EE)≧Ip (EL)+0.2 (eV).

<5> An organic electroluminescent device as described in the above <3> or <4>, wherein the electron-transporting material in the electron-transporting layer is an aromatic heterocyclic compound having one or more hetero atoms in its molecule.

<6> An organic electroluminescent device as described in any of the above <1> to <5>, wherein the hole-transporting material in the light-emitting layer is a condensed aromatic compound.

<7> An organic electroluminescent device as described in any of the above <1> to <6>, wherein the hole-transporting material in the light-emitting layer is a condensed aromatic compound represented by the following formula (1):

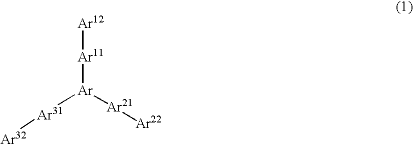

In the formula (1), Ar represents a polyvalent aromatic ring group; Ar¹¹, Ar²¹ and Ar³¹ independently represent each an arylene group; and Ar¹², Ar²² and Ar³² independently represent each a substituent or a hydrogen atom, provided that at least two of Ar¹¹, Ar²¹, Ar³¹, Ar¹², Ar²² and Ar³² are tricyclic or higher condensed aromatic hydrocarbon rings or condensed aromatic heterocycles.

<8> An organic electroluminescent device as described in any of the above <3> to <5>, wherein the hole-transporting material in the light-emitting layer is an anthracene compound represented by the following formula (2):

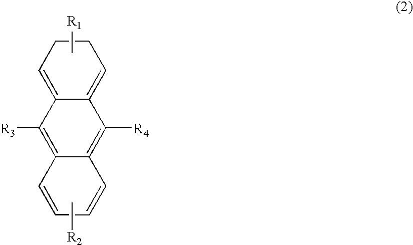

In the formula (2), R¹, R², R³ and R⁴ independently represent each an aryl group, an alkyl group having from 1 to 24 carbon atoms or a hydrogen atom.

<9> An organic electroluminescent device as described in any of the above <1> to <8>, wherein the electron-transporting material in the light-emitting layer is a metal complex compound.

Owing to the constitution as described above, the ionization potentials and electron affinities of the hole-transporting material, the electron-transporting material and the luminescent material in the light-emitting layer are defined in the organic electroluminescent device according to the invention. As a result, it becomes possible to exhibit the characteristics of the invention of inhibiting the decomposition starting from excitons thereof, further improving the durability, and establishing an extremely high luminance and an extremely high luminescence efficiency. It is considered that these favorable characteristics are achieved not only by the increase in the electrochemical stability in the light-emitting layer but also by the formation of excitons directly in the luminescent material in the light-emitting layer without mediated by energy transfer from host excitons.

Another characteristic of the invention resides in that the respective ionization potentials of the hole-transporting material in the hole-transporting layer, the hole-transporting material in the light-emitting layer, the electron-transporting material in the light-emitting layer and the electron-transporting material in the electron-transporting layer are defined so that the luminescence efficiency and the durability can be further improved.

According to the invention, an organic electroluminescent device which is highly excellent in durability and has an extremely high luminance and an extremely high luminescence efficiency can be provided.

### DETAILED DESCRIPTION OF THE INVENTION

The organic electroluminescent device according to the invention has organic layers comprising at least one light-emitting layer between a pair of electrodes, wherein the light-emitting layer contains a hole-transporting material, an electron-transporting material and a luminescent material, and the respective ionization potentials Ip (HL), Ip (EL) and Ip (L) of the hole-transporting material, the electron-transporting material and the luminescent material satisfy the following relationship:
Ip (L)≦IP (HL)≦Ip (EL).

By controlling the ionization potentials of the hole-transporting material, the electron-transporting material and the luminescent material in the light-emitting layer so as to satisfy the above relationship, the durability of the device can be elevated.

In addition, it is preferable that the respective electron affinities Ea (HL), Ea (EL) and Ea (L) of the hole-transporting material, the electron-transporting material and the luminescent material in the light-emitting layer as described above satisfy the following relationship:
Ea (L)≧Ea (EL)≧Ea (HL).

By controlling the electron affinities of the hole-transporting material, the electron-transporting material and the luminescent material in the light-emitting layer so as to satisfy the above relationship, the durability of the device can be further elevated.

Reasons for the improved durability of the device by controlling the ionization potentials and electron affinities of the hole-transporting material, the electron-transporting material and the luminescent material layer so as to satisfy the above relationships are estimated as follows.

As one of the reasons for the deterioration of durability, decomposition of the electron-transporting material due to the injection of holes to the electron-transporting material in the light-emitting layer can be cited.

As one of the reasons for the deterioration of durability, decomposition of the hole-transporting material due to the injection of electrons to the hole-transporting material in the light-emitting layer can be cited.

In the process of the formation of excitons in the light-emitting layer, on the other hand, the hole-transporting material or the electron-transporting material in the light-emitting layer serves as a host material. Namely, there is generally a light-emitting mechanism (an energy transfer mechanism) that proceeds as follows. First, excitons are formed in molecules of the host material and energy-transferred to the luminescent material. Then they become excitons in molecules of the luminescent material and cause light emission. In this case, there is a large problem in the exciton stability of the hole-transporting material or the electron-transporting material in the light-emitting layer. That is to say, a poor stability thereof results in deterioration of durability.

In the invention, the ratio of hole injection into the electron-transporting material in the light-emitting layer can be lowered by controlling the ionization potentials and electron affinities of the luminescent material, the hole-transporting material and the electron-transporting material in the light-emitting layer so as to satisfy the above relationships. It is also possible to lower the ratio of electron injection into the hole-transporting material in the light-emitting layer.

Moreover, it is possible to directly inject holes from the hole-transporting material into the luminescent material in the light-emitting layer. It is also possible to directly inject electrons from the electron-transporting material into the luminescent material in the light-emitting layer. As a result, excitons can be formed at an elevated ratio directly in the luminescent material without forming any excitons in the hole-transporting material or the electron-transporting material in the light-emitting layer, thereby further improving the durability.

By controlling the respective ionization potentials and electron affinities of the hole-transporting material, the electron-transporting material and the luminescent material in the light-emitting layer so as to satisfy the relationships as discussed above, factors causative of deterioration of the durability in the light-emitting layer can be eliminated and thus the durability can be largely improved.

Another embodiment of the organic electroluminescent device according to the invention is an organic electroluminescent device having a hole-transporting layer, a light-emitting layer and an electron-transporting layer between a pair of electrodes, wherein the light-emitting layer contains a hole-transporting material, an electron-transporting material and a luminescent material. The respective ionization potentials Ip (HH), Ip (HL), Ip (EL) and Ip (EE) of the hole-transporting material in the hole-transporting layer, the hole-transporting material in the light-emitting layer, the electron-transporting material in the light-emitting layer and the electron-transporting material in the electron-transporting layer satisfy the following relationship:
Ip (HH)≦IP (HL)≦Ip (EL)<Ip (EE).

By satisfying the above relationship, passing of holes can be prevented in the light-emitting layer and an organic electroluminescent device having an excellent durability can be obtained.

The organic electroluminescent device according to the invention can achieve a further elevated effect in the case where the ionization potential (Ip (EL)) of the electron-transporting material in the light-emitting layer and the ionization potential (Ip (EE)) of the electron-transporting material in the electron-transporting layer satisfy the following relationship:
Ip (EE)≧Ip (EL)+0.2 (eV).

The hole-transporting material in the light-emitting layer to be used in the invention is not particularly restricted, so long as the ionization potential and the electron affinity thereof satisfy the above-described relationships for carrying out the invention. For example, use can be made of the following materials. Namely, examples thereof include condensed aromatic compounds, carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted chalcone derivatives, styrylanthrazene derivatives, fluorenone derivatives, hydrazone derivatives, stilbene derivatives, silazane derivatives, aromatic tertiary amine compounds, styrylamine compounds, aromatic dimethylidene compounds, porphyrin compounds and so on.

Among all, condensed aromatic compounds are preferable in the invention from the viewpoint of durability and condensed aromatic compounds represented by the following formula (1) are preferred.

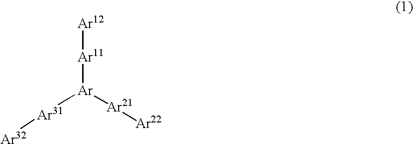

In the formula (1), Ar represents a polyvalent aromatic ring group; Ar¹¹, Ar²¹ and Ar³¹ independently represent each an arylene group; and Ar¹², Ar²² and Ar³² independently represent each a substituent or a hydrogen atom. At least two of Ar¹¹, Ar²¹, Ar³¹ Ar¹², Ar²² and Ar³² are tricyclic or higher condensed aromatic hydrocarbon rings or condensed aromatic heterocycles.

Next, the formula (1) will be illustrated in greater detail.

Ar¹¹, Ar²¹ and Ar³¹ represent each an arylene group. Such an arylene group has preferably from 6 to 30, still preferably from 6 to 20 and still preferably from 6 to 16, carbon atoms. Examples of the arylene group include a phenylene group, a naphthylene group, an anthrylene group, a phenanthrenylene group, a pyrenylene group, a perylenylene group, a fluorenylene group, a biphenylene group, a terphenylene group, a rubrenylene group, a chrycenylene group, a triphenylene group, a benzoanthrylene group, a benzophenanthrenylene group, a diphenylanthrylene group and so on. These arylene groups may further have substituent(s) selected from among the following substituent group A.

(Substituent Group A)

Alkyl groups (preferably having from 1 to 30 carbon atoms, still preferably from 1 to 20 carbon atoms and particularly preferably from 1 to 10 carbon atoms, such as methyl, ethyl, isopropyl, tert-butyl, n-octyl, n-decyl, n-hexadecy, cyclopropyl, cyclopentyl and cyclohexyl groups), alkenyl groups (preferably having from 2 to 30 carbon atoms, still preferably from 2 to 20 carbon atoms and particularly preferably from 2 to 10 carbon atoms, such as vinyl, allyl, 2-butenyl and 3-pentenyl groups), alkynyl groups (preferably having from 2 to 30 carbon atoms, still preferably from 2 to 20 carbon atoms and particularly preferably from 2 to 10 carbon atoms, such as propargyl and 3-pentynyl groups), aryl groups (preferably having from 6 to 30 carbon atoms, still preferably from 6 to 20 carbon atoms and particularly preferably from 6 to 12 carbon atoms, such as phenyl, p-methylphenyl, naphthyl and anthranyl groups), amino groups (preferably having from 0 to 30 carbon atoms, still preferably from 0 to 20 carbon atoms and particularly preferably from 0 to 10 carbon atoms, such as amino, methylamino, dimethylamino, diethylamino, dibenzylamino, diphenylamino and ditolylamino groups), alkoxy groups (preferably having from 1 to 30 carbon atoms, still preferably from 1 to 20 carbon atoms and particularly preferably from 1 to 10 carbon atoms, such as methoxy, ethoxy, butoxy and 2-ethylhexyloxy groups), aryloxy groups (preferably having from 6 to 30 carbon atoms, still preferably from 6 to 20 carbon atoms and particularly preferably from 6 to 12 carbon atoms, such as phenyloxy, 1-naphthyloxy and 2-naphthyloxy groups), heteroaryl groups (preferably having from 1 to 30 carbon atoms, still preferably from 1 to 20 carbon atoms and particularly preferably from 1 to 12 carbon atoms, such as pyridyloxy, pyrazyloxy, pyrimidyloxy and quinolyloxy groups), acyl groups (preferably having from 1 to 30 carbon atoms, still preferably from 1 to 20 carbon atoms and particularly preferably from 1 to 12 carbon atoms, such as acetyl, benzoyl, formyl and pivaloyl groups), alkoxycarbonyl groups (preferably having from 2 to 30 carbon atoms, still preferably from 2 to 20 carbon atoms and particularly preferably from 2 to 12 carbon atoms, such as methoxycarbonyl and ethoxycarbonyl groups), aryloxycarbonyl groups (preferably having from 7 to 30 carbon atoms, still preferably from 7 to 20 carbon atoms and particularly preferably from 7 to 12 carbon atoms, such as a phenyloxycarbonyl group), acyloxy groups (preferably having from 2 to 30 carbon atoms, still preferably from 2 to 20 carbon atoms and particularly preferably from 2 to 10 carbon atoms, such as acetoxy and benzoyloxy groups), acylamino groups(preferably having from 2 to 30 carbon atoms, still preferably from2 to 20 carbon atoms and particularly preferably from 2 to 10 carbon atoms, such as acetylamino and benzoylamino groups), alkoxycarbonylamino groups (preferably having from 2 to 30 carbon atoms, still preferably from 2 to 20 carbon atoms and particularly preferably from 2 to 12 carbon atoms, such as a methoxycarbonylamino group), aryloxycarbonylamino groups (preferably having from 7 to 30 carbon atoms, still preferably from 7 to 20 carbon atoms and particularly preferably from 7 to 12 carbon atoms, such as a phenyloxycarbonylamino group), sulfonylamino groups (preferably having from 1 to 30 carbon atoms, still preferably from 1 to 20 carbon atoms and particularly preferably from 1 to 12 carbon atoms,-such as methanesulfonylamino and benzenesulfonylamino groups), sulfamoyl groups (preferably having from 0 to 30 carbon atoms, still preferably from 0 to 20 carbon atoms and particularly preferably from 0 to 12 carbon atoms, such as sulfamoyl, methylsulfamoyl, dimethylsulfamoyl and phenylsulfamoyl groups), carbamoyl groups (preferably having from 1 to 30 carbon atoms, still preferably from 1 to 20 carbon atoms and particularly preferably from 1 to 12 carbon atoms, such as carbamoyl, methylcarbamoyl, diethylcarbamoyl and phenylcarbamoyl groups), alkylthio groups (preferably having from 1 to 30 carbon atoms, still preferably from 1 to 20 carbon atoms and particularly preferably from 1 to 12 carbon atoms, such as methylthio and ethylthio groups), arylthio groups (preferably having from 6 to 30 carbon atoms, still preferably from 6 to 20 carbon atoms and particularly preferably from 6 to 12 carbon atoms, such as a phenylthio group), heteroarylthio groups (preferably having from 1 to 30 carbon atoms, still preferably from 1 to 20 carbon atoms and particularly preferably from 1 to 12 carbon atoms, such as pyridylthio, 2-benzimidazolylthio, 2-benzimidazolylthio and 2-benzithiazolylthio groups), sulfonyl groups (preferably having from 1 to 30 carbon atoms, still preferably from 1 to 20 carbon atoms and particularly preferably from 1 to 12 carbon atoms, such as mesyl and tosyl groups), sulfinyl groups (preferably having from 1 to 30 carbon atoms, still preferably from 1 to 20 carbon atoms and particularly preferably from 1 to 12 carbon atoms, such as methanesulfinyl and benzenesulfinyl groups), ureido groups (preferably having from 1 to 30 carbon atoms, still preferably from 1 to 20 carbon atoms and particularly preferably from 1 to 12 carbon atoms, such as ureido, methylureido and phenylureido groups), phosphoramido groups (preferably having from 1 to 30 carbon atoms, still preferably from 1 to 20 carbon atoms and particularly preferably from 1 to 12 carbon atoms, such as diethyolphosphoramido and phenylphosphoramido groups), a hydroxyl group, a mercapto group, halogen atoms (for example, a fluorine atom, a chlorine atom, a bromine atom and an iodine atom), a cyano group, a sulfo group, a carboxyl group, a nitro group, a hydroxamate group, a sulfino group, a hydrazino group, an imino group, heterocyclic groups (preferably having from 1 to 30 carbon atoms, still preferably from 1 to 12 carbon atoms, and the hetero atom being, for example, a nitrogen atom, an oxygen atom or a sulfur atom, such as imidazolyl, pyridyl, quinolyl, furyl, thienyl, piperidyl, morpholino, benzoxazolyl, benzimidazolyl, benzthiazolyl, carbazolyl and azepinyl groups), silyl groups (preferably having from 3 to 40 carbon atoms, still preferably from 3 to 30 carbon atoms and particularly preferably from 3 to 34 carbon atoms, such as trimethylsilyl and triphenylsilyl groups) and so on.

These substituents may be further-substituted by substituent(s) selected from the substituent group A.

It is preferable that the above-described Ar¹¹, Ar²¹ and Ar³¹ represent each a phenylene group, a naphthylene group, an anthrylene group, a phenanthrenylene group, a biphenylene group, a tetracyclic or higher arylene group (for example, a pyrenylene or perylenylene group), still preferably a phenylene group, a naphthylene group, a phenanthrenylene group or a tetracyclic or higher arylene group, still preferably a phenylene group, a phenanthrenylene group or a pyrenylene group, and particularly preferably a pyrenylene group.

The above-described Ar¹², Ar²² and Ar³² represent each a substituent or a hydrogen atom. Examples of the substituent include substituents selected from the above-described substituent group A.

It is preferable that Ar¹², Ar²² and Ar³² represent each a hydrogen atom, an aryl group, a heteroaryl group, an alkyl group or an alkenyl group, still preferably a hydrogen atom, an aryl group or a heteroaryl group, and still preferably a hydrogen atom or an aryl group, and particularly preferably a hydrogen atom or a pyrenyl group.

At least two of Ar¹¹, Ar²¹ Ar³¹ Ar¹², Ar²² and Ar³² are tricyclic or higher condensed aromatic hydrocarbon rings or condensed aromatic heterocycles, preferably a tricyclic or higher condensed aromatic carbon ring.

Preferable examples of the tricyclic or higher condensed aromatic carbon ring include a naphthalene ring, an anthracene ring, a phenanthrene ring, a pyrene ring or a perylene ring, still preferably an aphthalene ring, an anthracene ring, a pyrene ring or a phenanthrene ring, still preferably a phenanthrene ring or a tetracyclic or higher aryl ring and particularly preferably a pyrene ring.

Preferable examples of the tricyclic or higher condensed aromatic rings include a quinoline ring, a quinoxaline ring, a quinazoline ring, an acridine ring, a phenanthridine ring, a phthalazine ring and a phenanthroline ring. A quinoline ring, a quinoxaline ring, a quinazoline ring and a phenanthroline ring are still preferable.

In the formula (1), Ar represents a polyvalent aromatic ring group. More specifically, it represents an arylene group which is a trivalent or higher group (preferably having from 6 to 30 carbon atoms, still preferably from 6 to 20 carbon atoms and still preferably from 6 to 16 carbon atoms such as a phenylene group, a naphthylene group, an anthracenylene group, a phenanthrene group, a pyrenylene group or a triphenylene group) or a heteroarylene group (the hetero atom being preferably a nitrogen atom, a sulfur atom or an oxygen atom, still preferably a nitrogen atom, and preferably having from 2 to 30 carbon atoms, still preferably from 3 to 20 carbon atoms and still preferably from 3 to 16 carbon atoms such as a pyridylene group, a pyrazylene group, a thiophenylene group, a quinolylene group, a quinoxalylene group or a triazylene group). These groups may further have substituent(s). As examples of the substituents, substituents selected from the above-described substituent group A may be cited. Divalent groups are given herein as representatives for trivalent or higher groups.

Ar preferably represents a phenylene group (benzenetriyl), a napthylene group (naphthalenetrily), an anthracenylene group (anthracenetriyl), a pyrenylene group (pyrenetrily) or a triphenylene group, still preferably a phenylene group. It is still preferably that Ar is an unsubstituted (all being hydrogen atoms but Ar¹¹, Ar²¹ and Ar³¹) phenylene group or an alkyl-substituted phenylene group.

Next, examples of the condensed aromatic compound represented by the formula (1) will be given, though the invention is not restricted thereto.

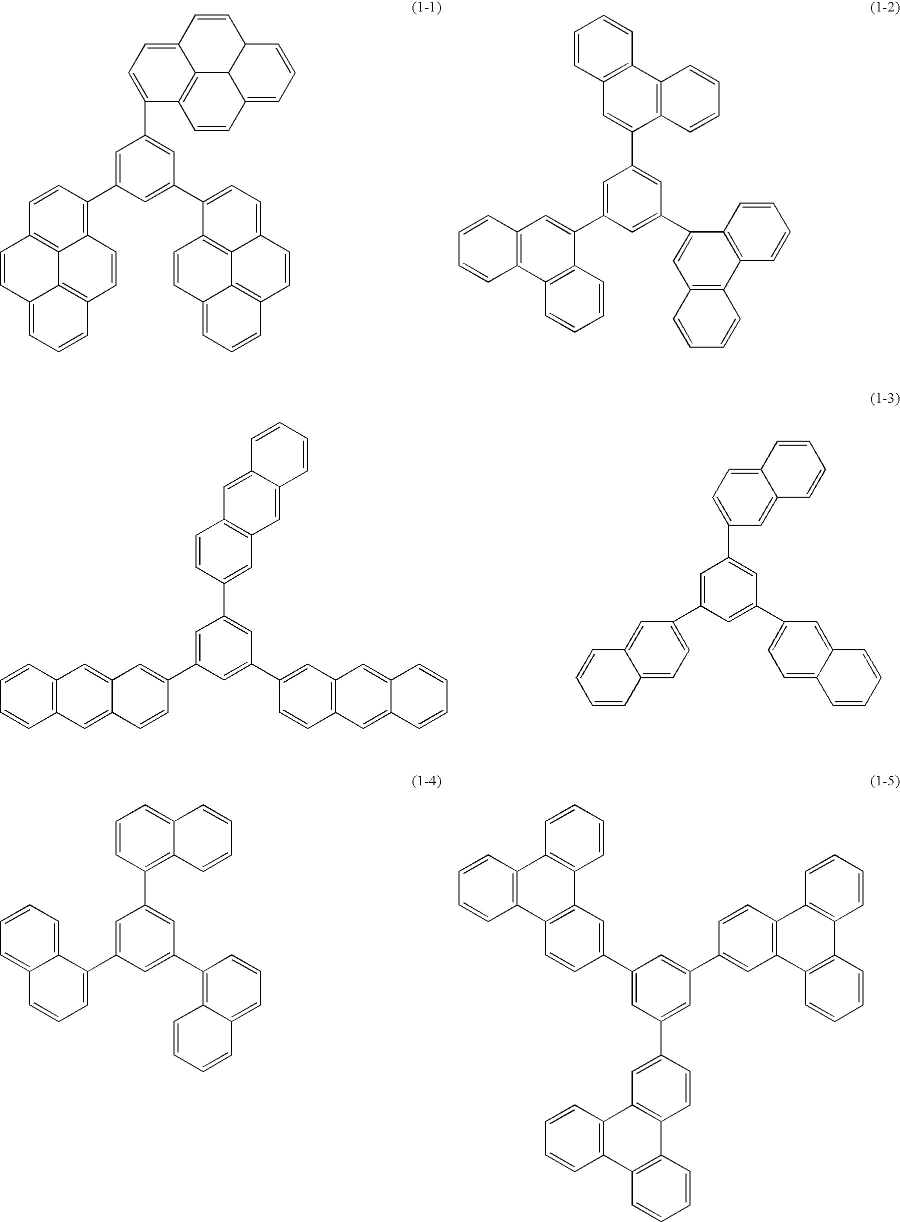

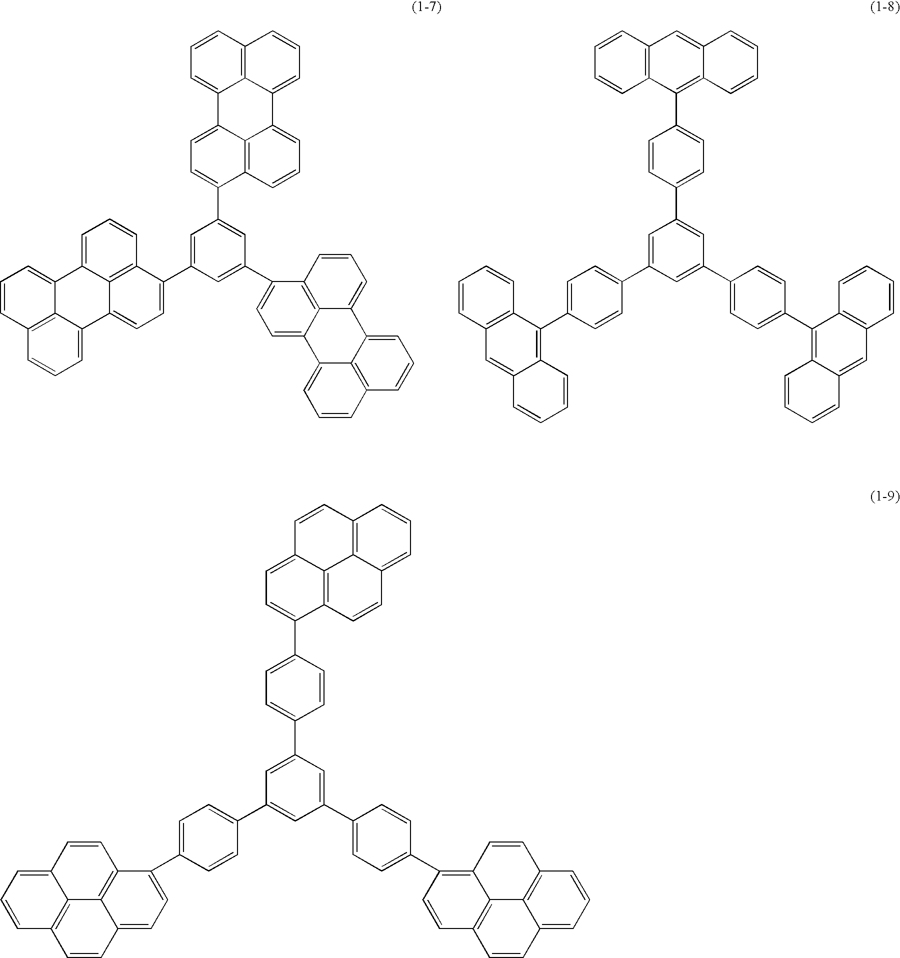

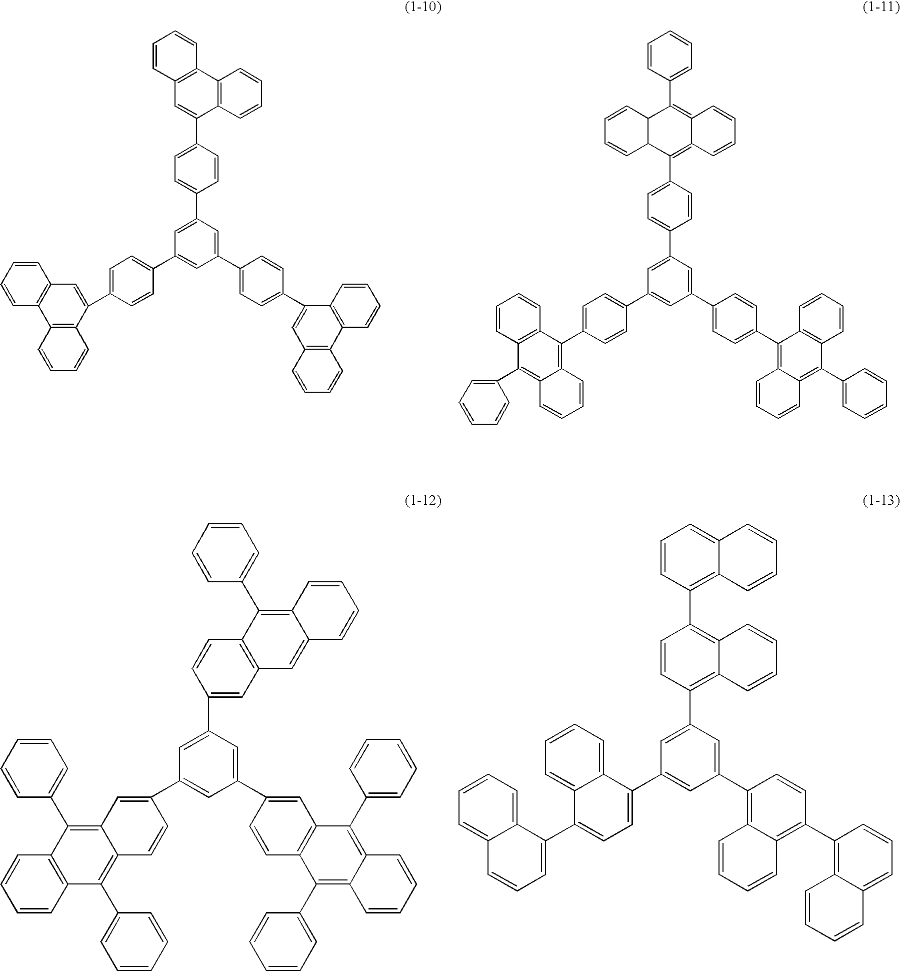

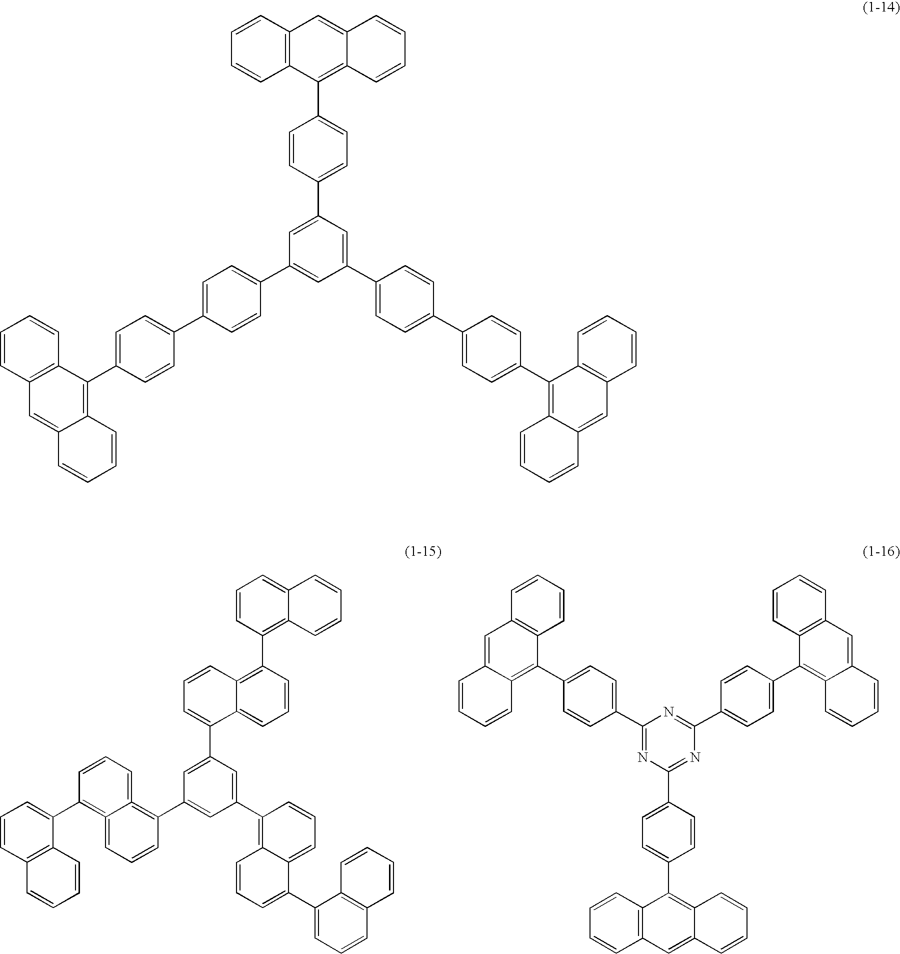

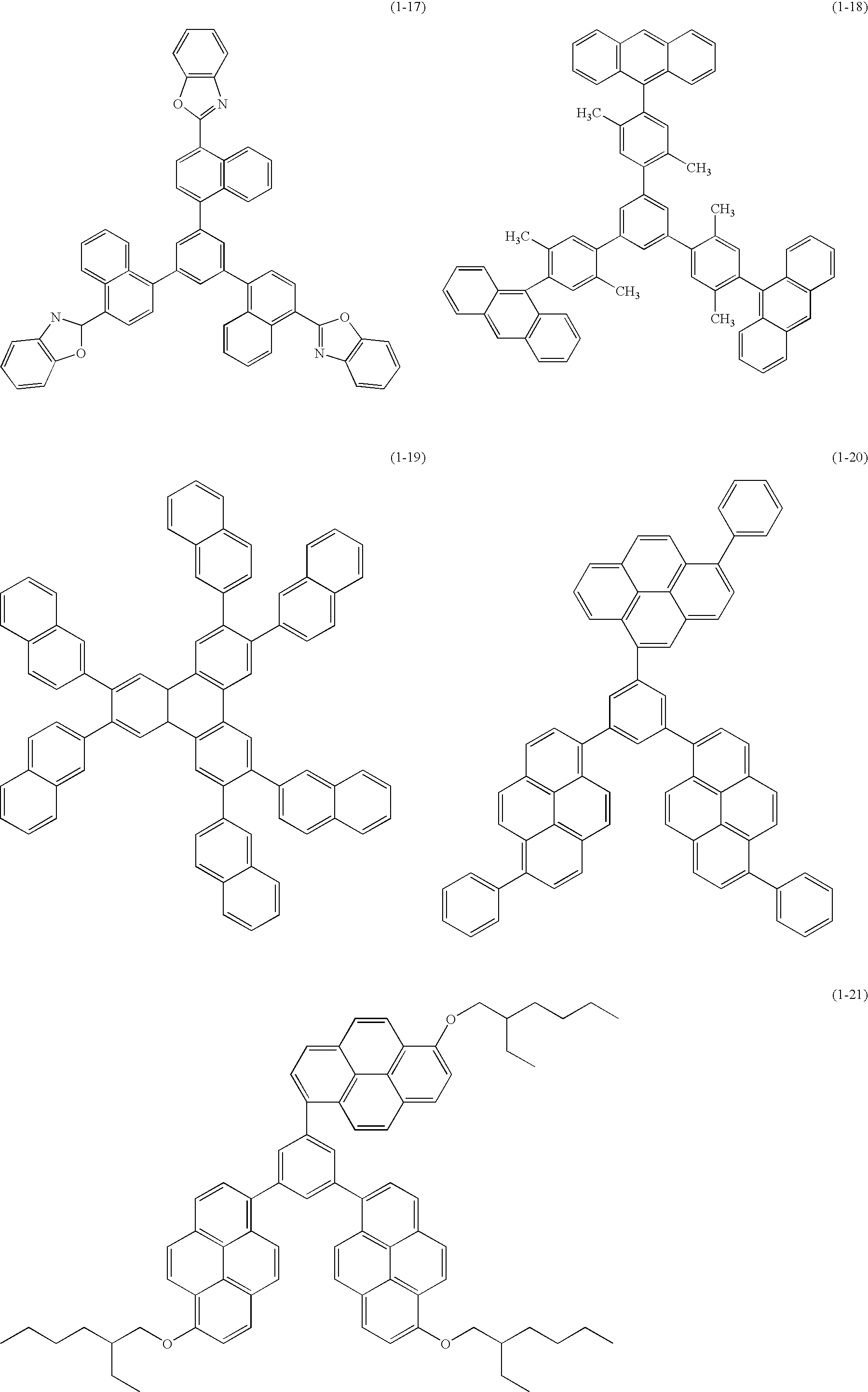

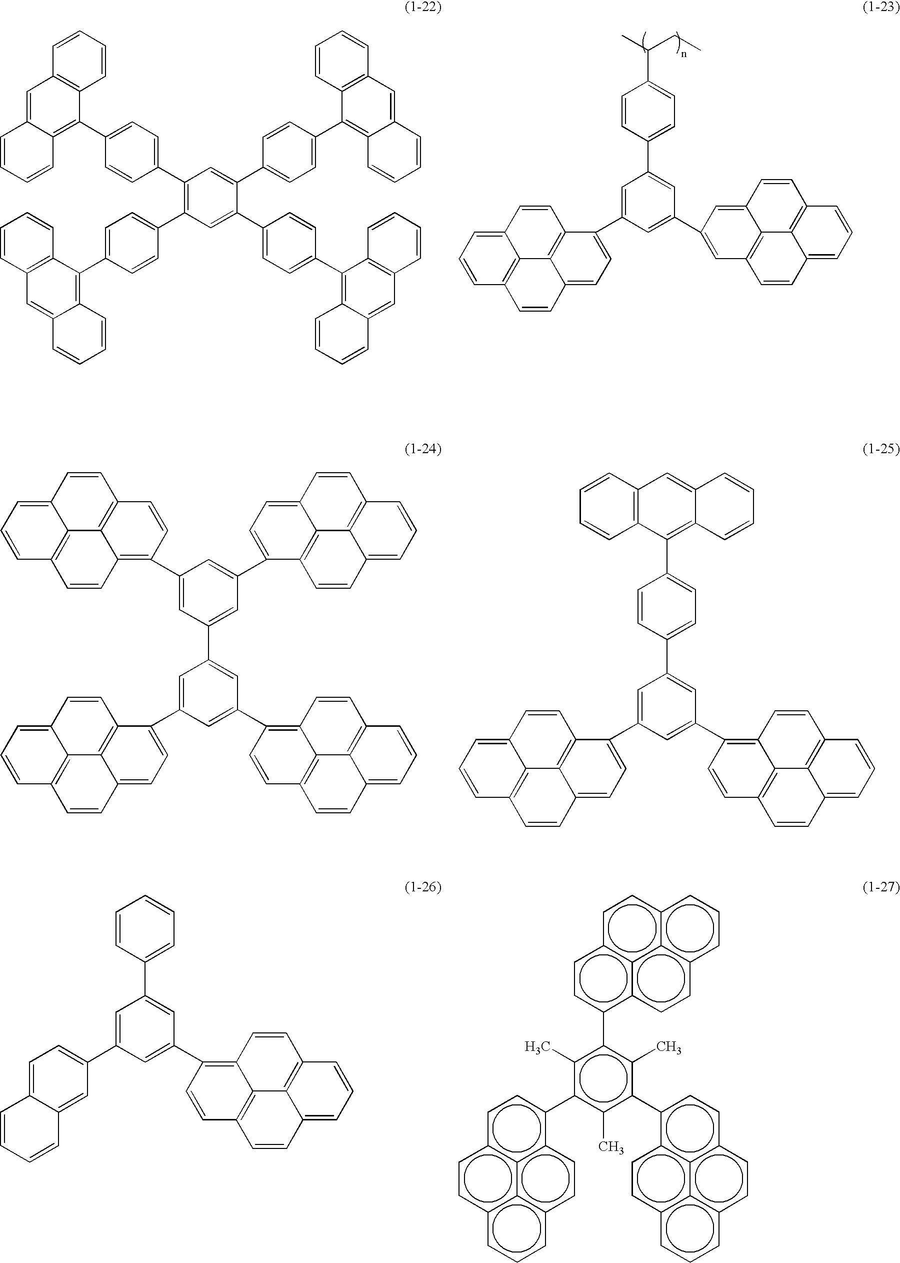

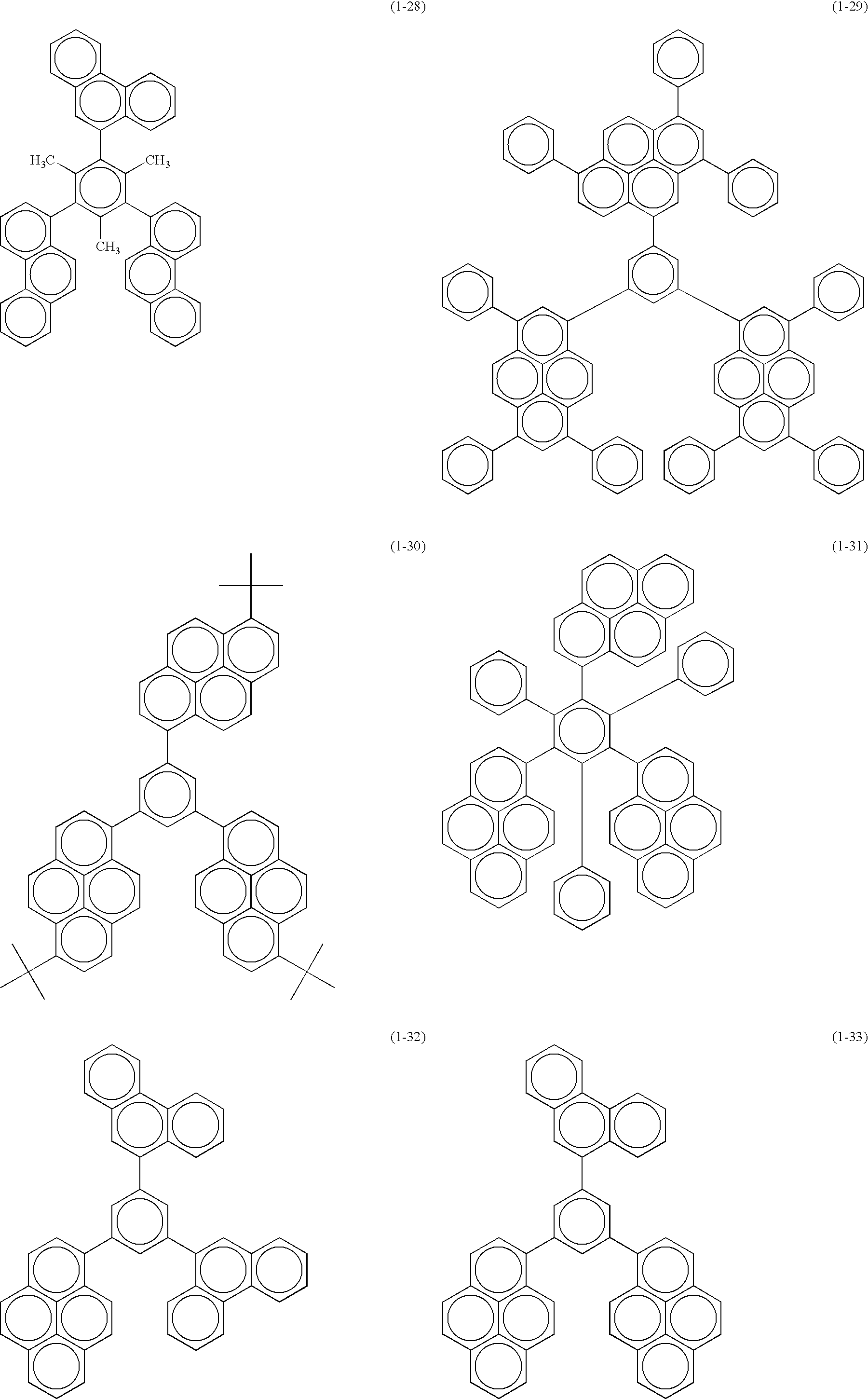

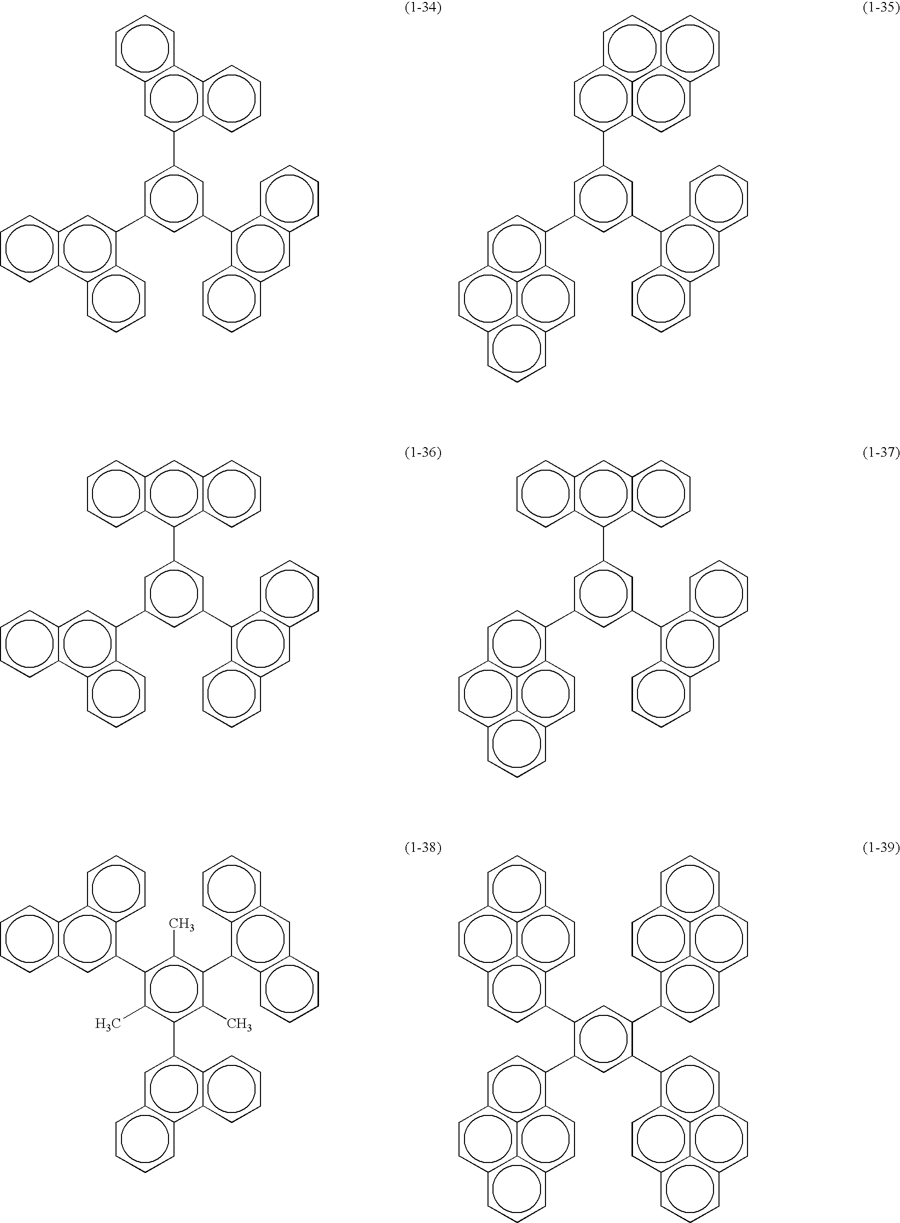

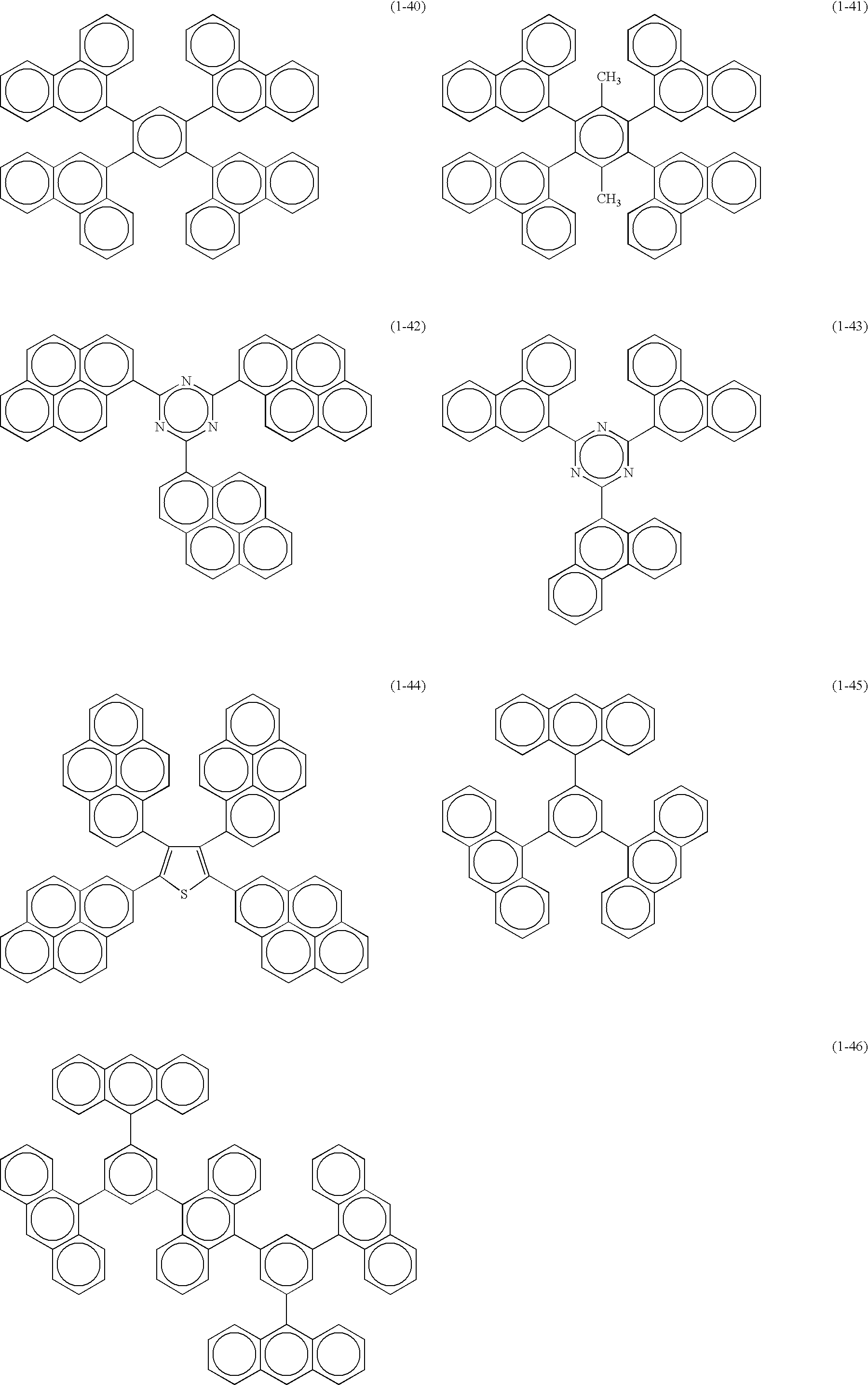

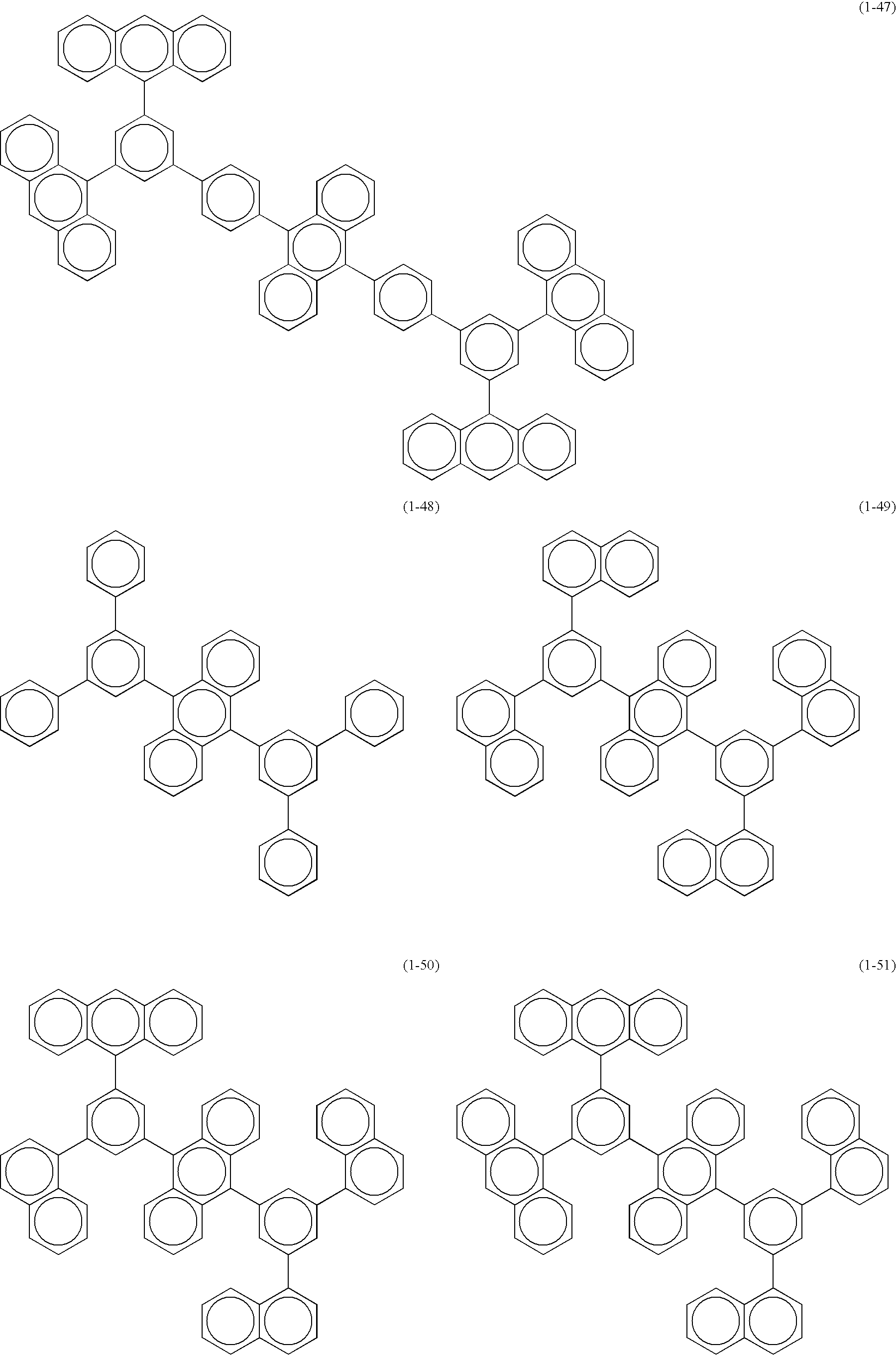

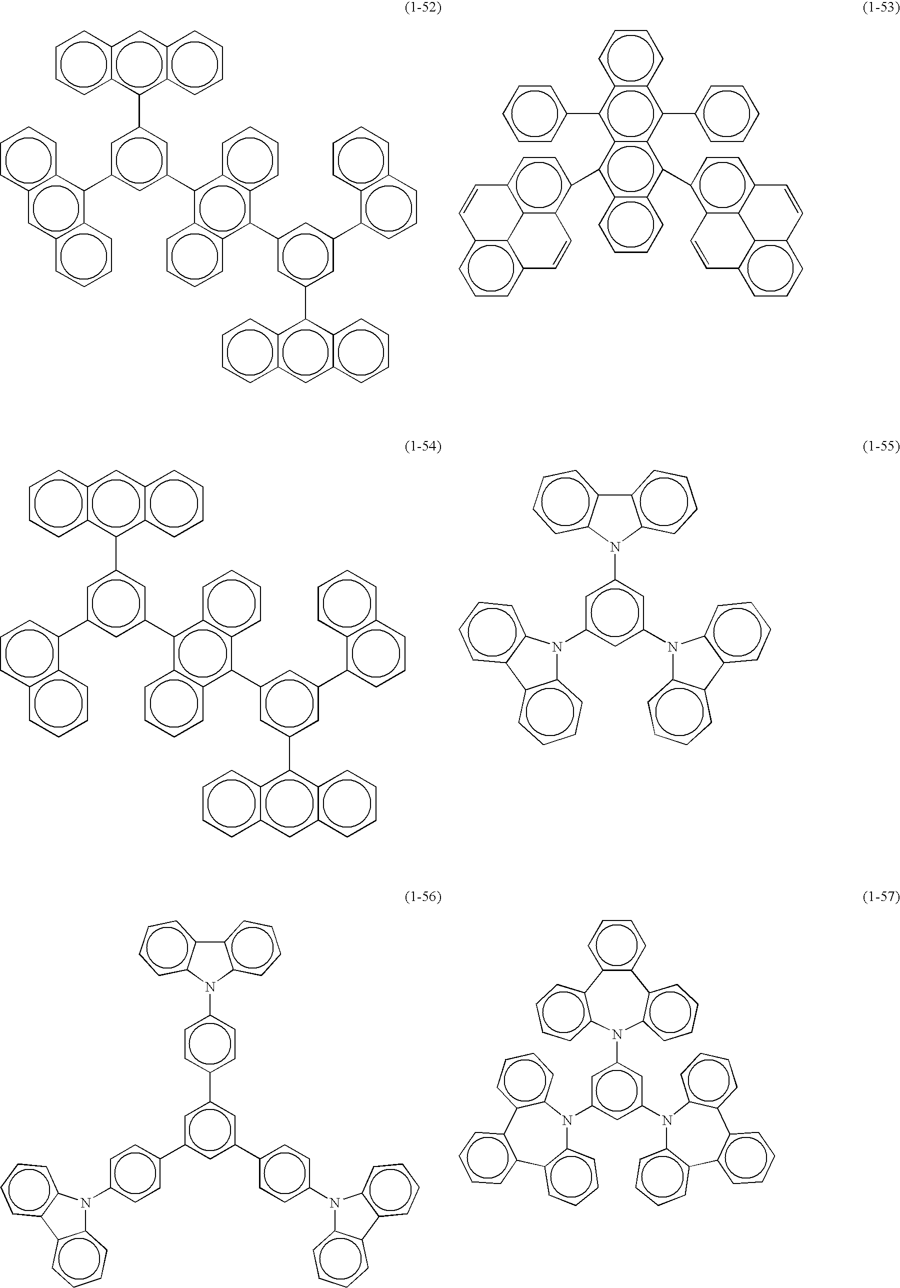

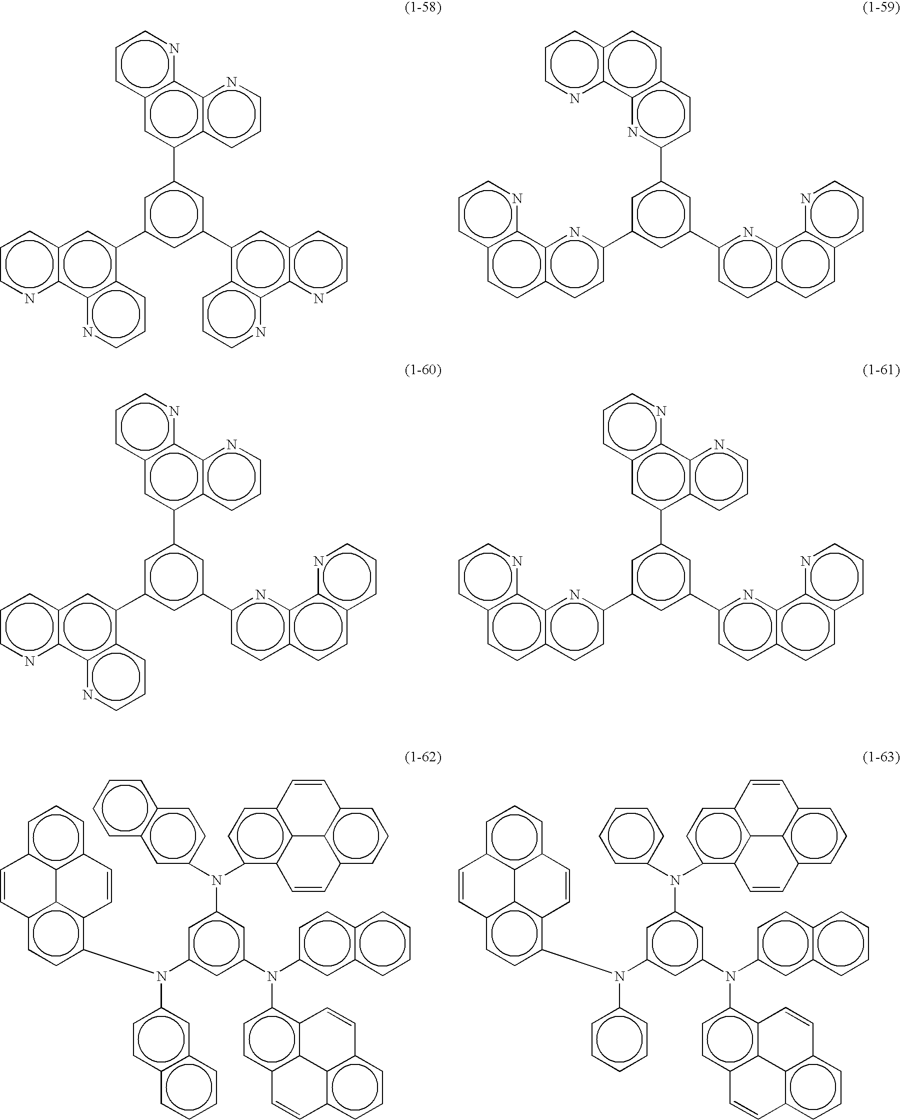

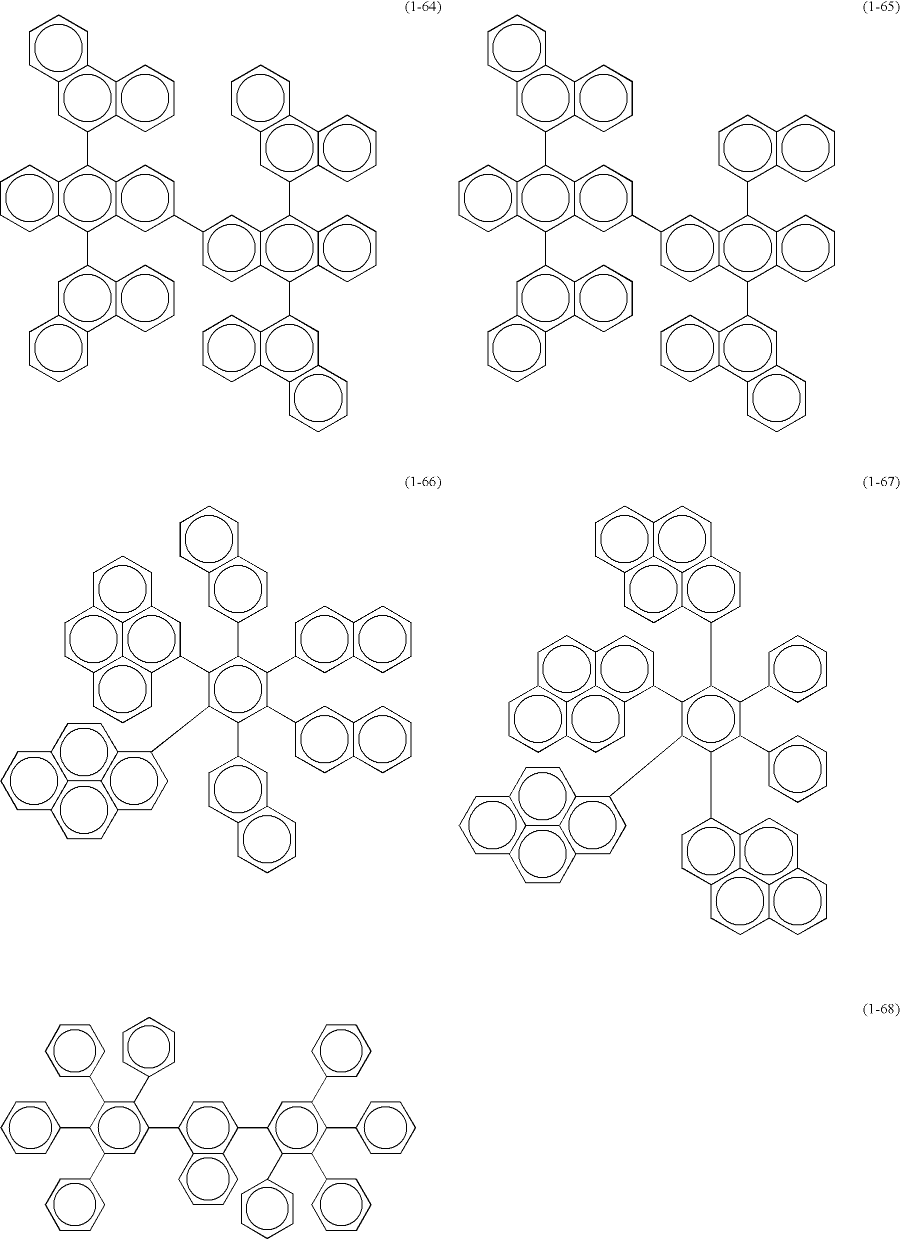

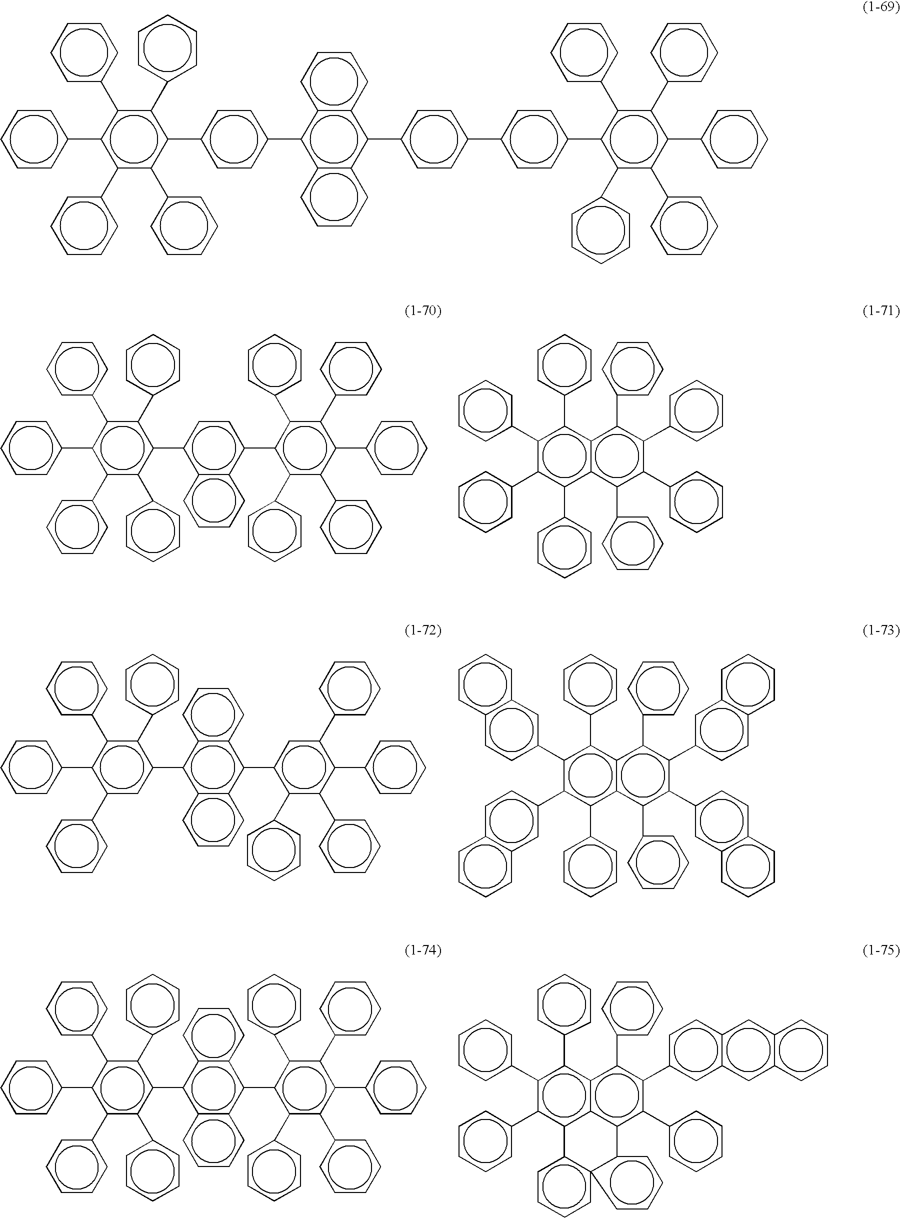

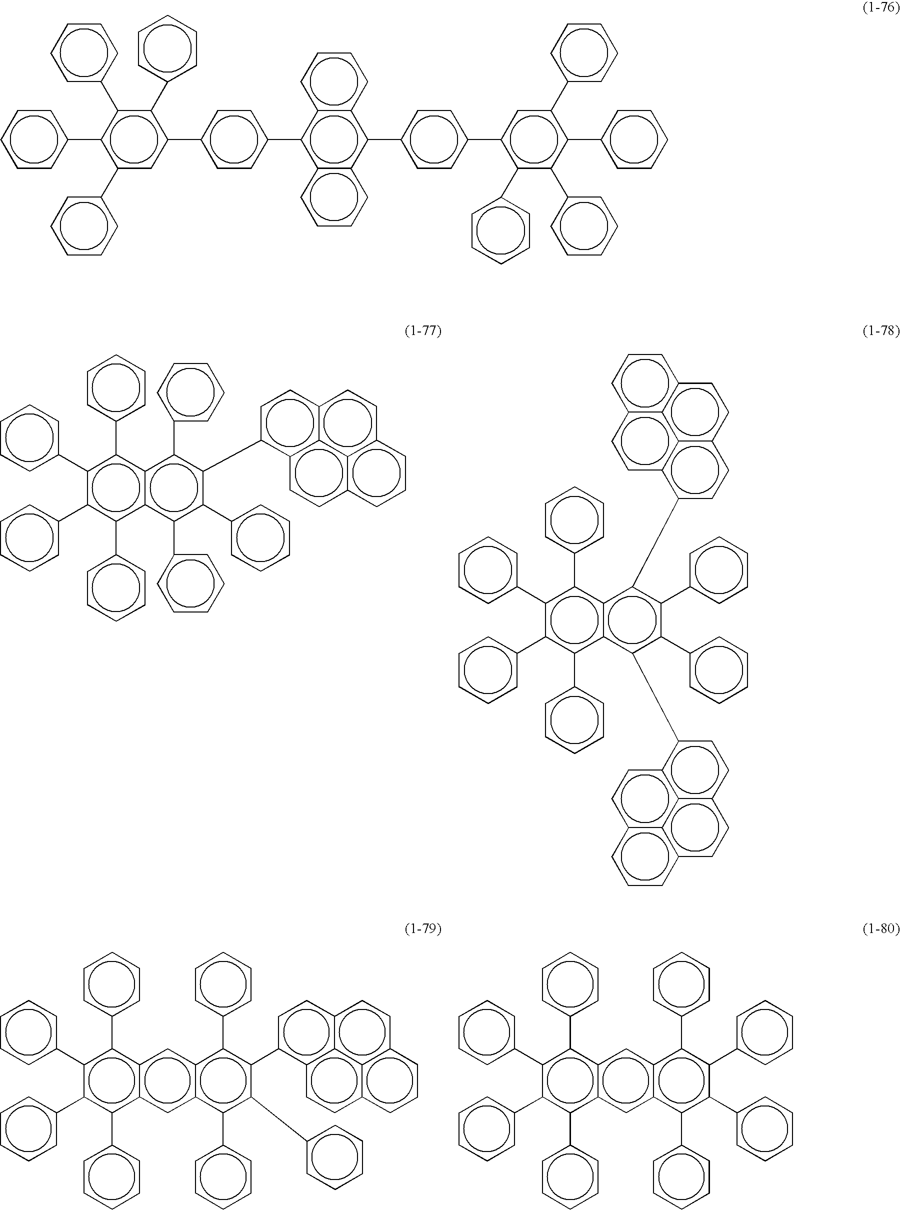

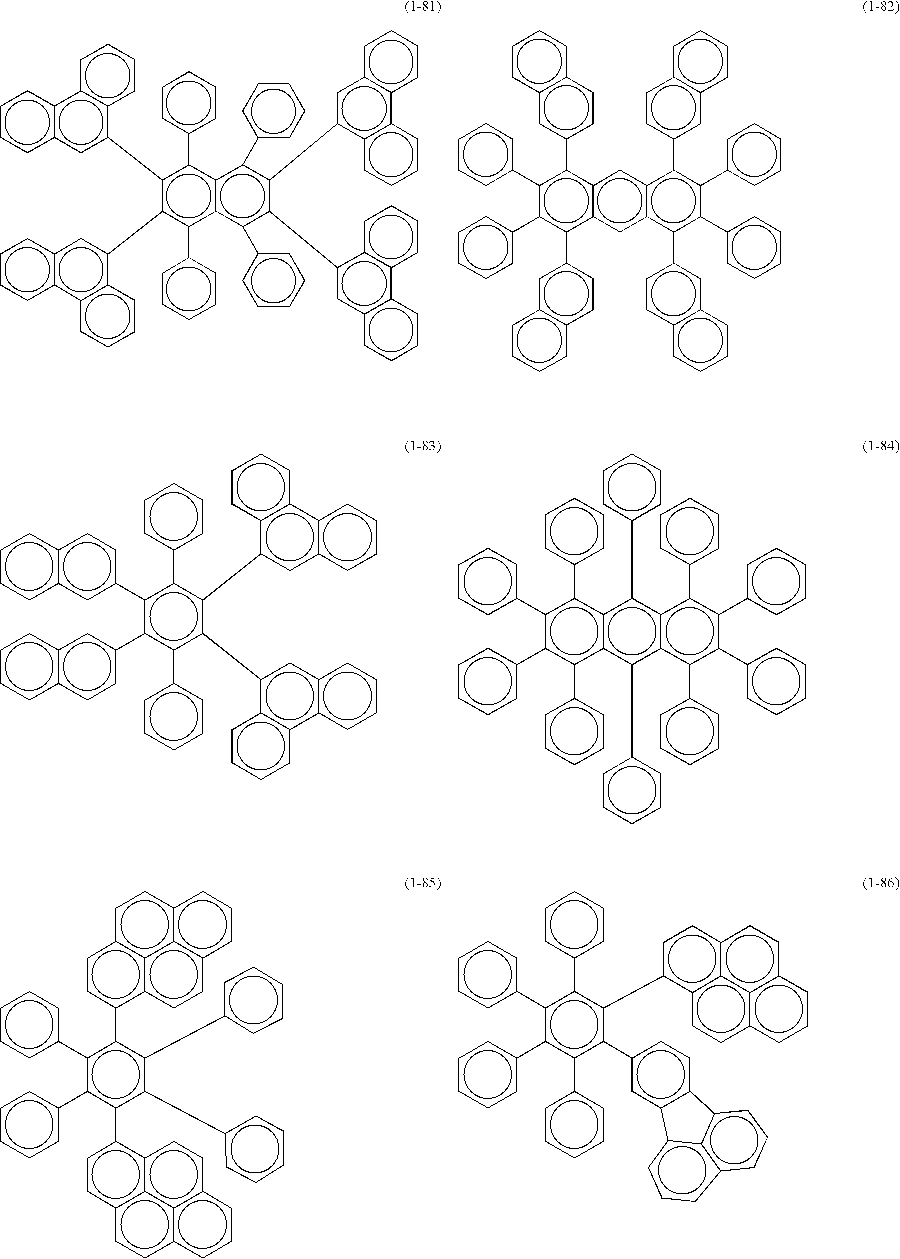

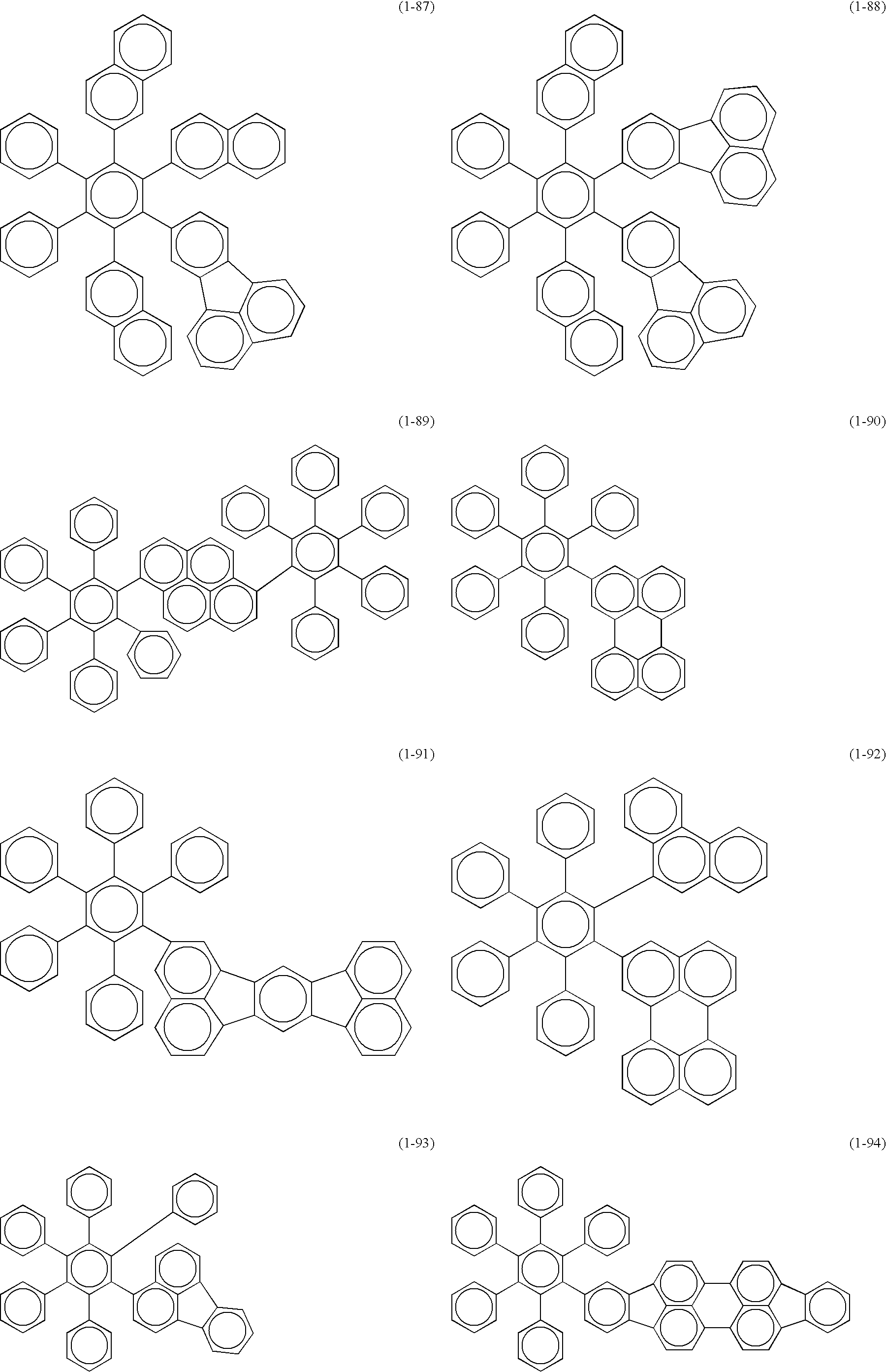

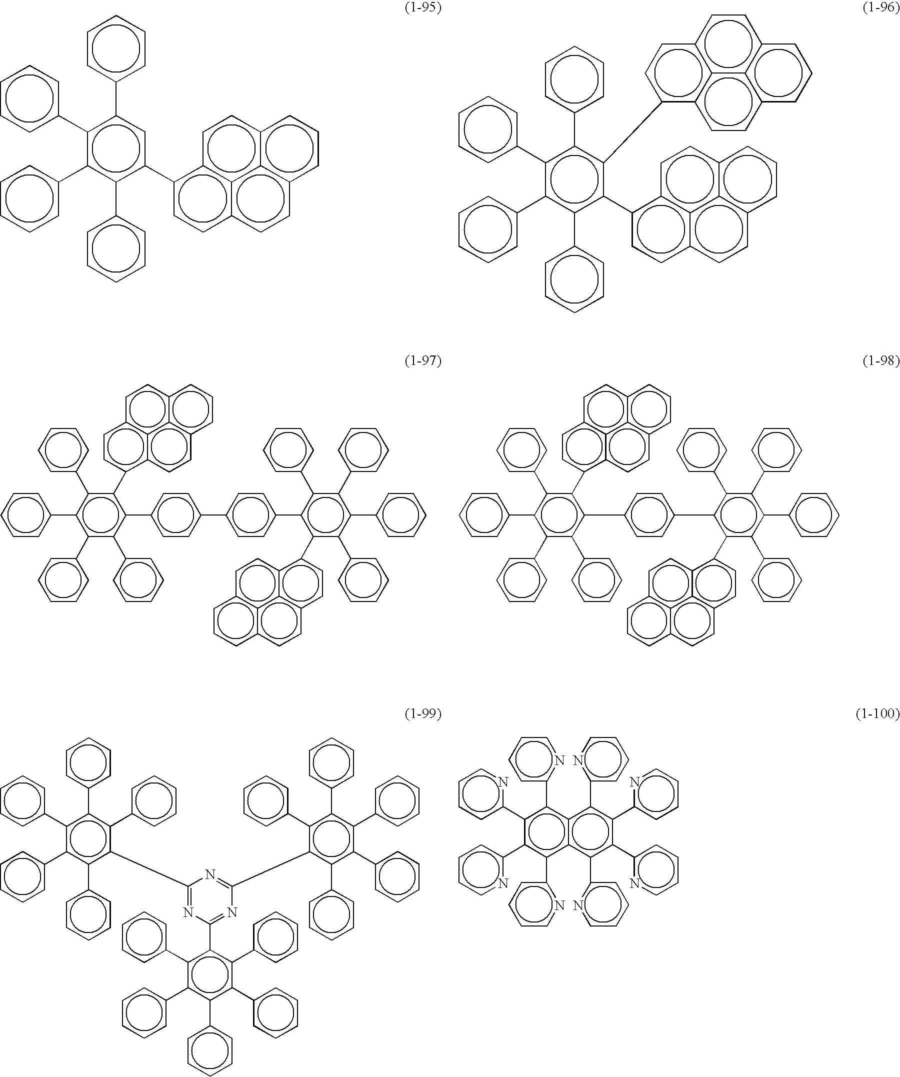

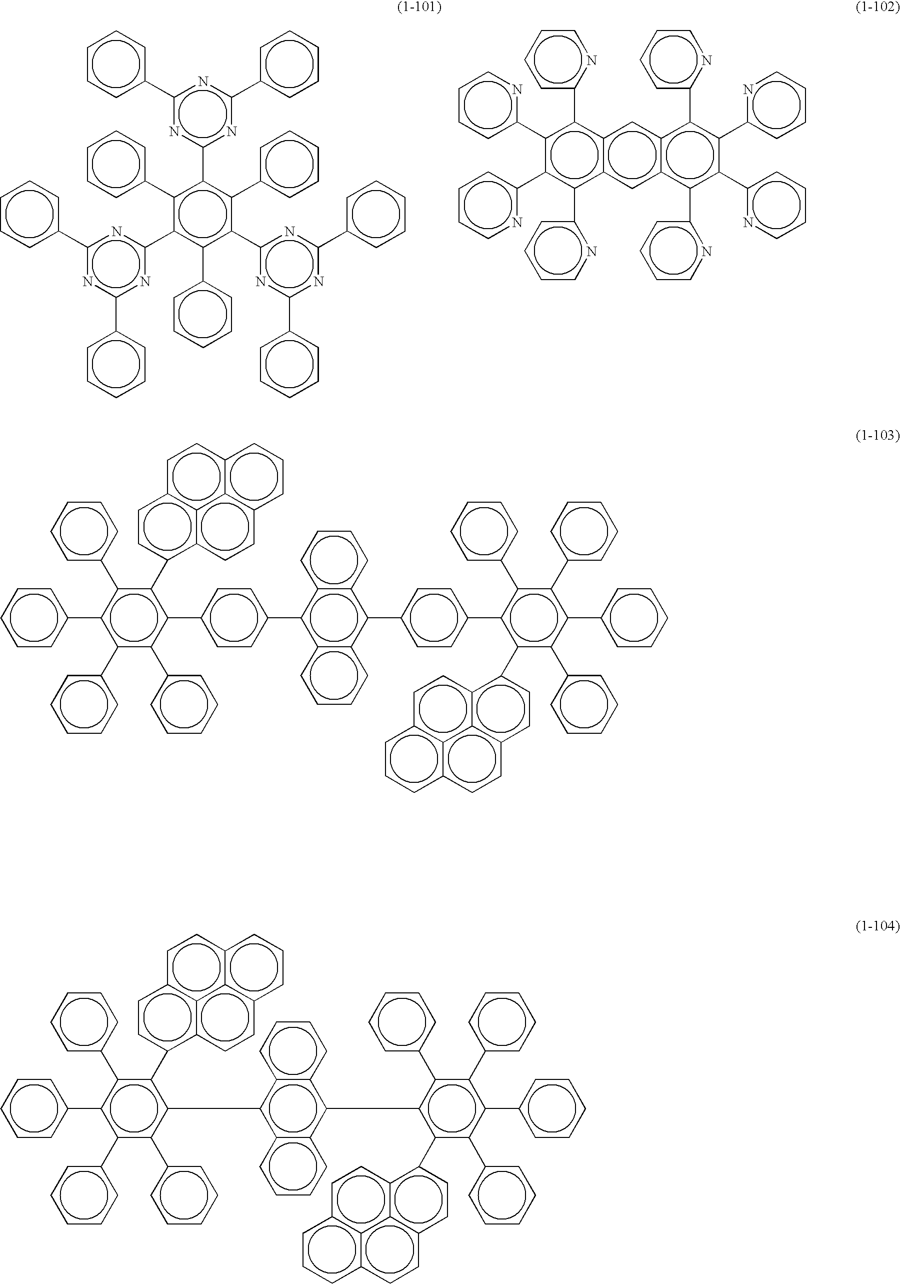

The condensed aromatic compounds represented by the formula (1) can be synthesized by, for example, a method described in JP-A-2002-338957.

In the invention, it is preferred that the hole-transporting material in the light-emitting layer is an anthracene compound represented by the following formula (2).

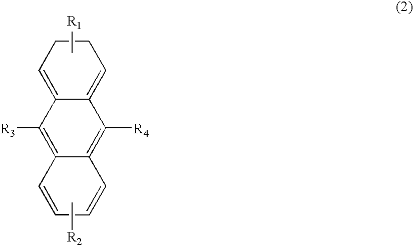

In the formula (2), R¹, R², R³and R⁴ independently represent each an aryl group, an alkyl group having from 1 to 24 carbon atoms or a hydrogen atom.

Preferable examples of the aryl groups represented by R¹, R², R³and R⁴ in the formula (2) include optionally substituted phenyl, naphthyl and anthranyl groups. Preferable examples of the alkyl groups having from 1 to 24 carbon atoms represented by R¹, R², R³ and R⁴ include a methyl group, an ethyl group, an n-propyl group, an i-propyl group, an n-butyl group, an i-butyl group, a sec-butyl group and a t-butyl group. These aryl groups and alkyl groups may have substituent(s). Examples of the substituents include the substituents selected from the above-described substituent group A.

More specifically speaking, it is possible to use, as the anthracene compound represented by the formula (2), compounds disclosed in, for example, JP-A-2002-260861 (the formula (1-a) or (1-b) being preferred) and JP-A-2001-284050 (the compounds described in paragraphs 0017 to 0020).

The electron-transporting material in the light-emitting layer to be used in the present invention is not particularly restricted, so long as its ionization potential and electron affinity satisfy the above-described relationships. For example, use can be made of the following materials.

That is, it is possible to use triazole derivatives, oxazole derivatives, oxadiazole derivatives, fluorenone derivatives, anthrone derivatives, diphenylquinone derivatives, thiopyran dioxide derivatives, carbodiimide derivatives, fluorenylidene methane derivatives, distyrylpyrazine derivatives, heterocyclic tetracarboxylic anhydrides such as naphthalene and perylene, phthalocyanine derivatives, various metal complexes typified by metal complexes of 8-quinollinol derivatives, metallo-phthalocyanines and metal complexes having benzoxazole or benzothiazole as a ligand and so on.

Among all, it is preferable in the invention to use a metal complex compound from the viewpoint of durability. A metal complex compound means a metal complex carrying a ligand having at least one nitrogen atom, oxygen atom or sulfur atom coordinating to a metal. The ligand may have two or more ligand atoms of different types.

Although the metal ion in the metal complex is not particularly restricted, preferable examples thereof include a beryllium ion, a magnesium ion, an aluminum ion, a gallium ion, a zinc ion, an indium ion and a tin ion. A beryllium ion, an aluminum ion, a gallium ion and a zinc ion are still preferable and an aluminum ion and a zinc ion are still preferable.

As the ligands contained in the above metal complexes, there have been publicly known various ligands. For example, ligands described in H. Yersin, Photochemistry and Photophysics of Coordination Compounds, Springer-Verlag, 1987 and Yamamoto Akio, Yukikinzokukagaku-kiso to ohyo, Shokabo Publishing Co., 1982 may be cited.

Preferable examples of the above-described ligand include nitrogen-containing heterocyclic ligands (preferably having from -1 to 30 carbon atoms, still preferably from 2 to 20 carbon atoms and particularly preferably from 3 to 15 carbon atoms; being either a unidentate ligand or a bidentate ligand, preferably being a bidentate ligand such as a pyridyl ligand, a dipyridyl ligand, a quinolinol ligand or a hydroxyphenylazole ligand (for example, a hydroxyphenylbenzimidazole ligand, a hydroxyphenylbenzoxazole ligand and a hydroxyphenylimidazole ligand)), alkoxy ligands (preferably having from 1 to 30 carbon atoms, still preferably from 1 to 20 carbon atoms and particularly preferably from 1 to 10 carbon atoms such as methoxy, ethoxy, butoxy and 2-ethylhexyloxy ligands), aryloxy ligands (preferably having from 6 to 30 carbon atoms, still preferably from 6 to 20 carbon atoms and particularly preferably from 6 to 12 carbon atoms such as phenyloxy, 1-naphthyloxy, 2-naphthyloxy, 2,4,6-trimethylphenyloxy and 4-biphenyloxy ligands), heteroaryloxy ligands (preferably having from 1 to 30 carbon atoms, still preferably from 1 to 20 carbon atoms and particularly preferably from 1 to 10 carbon atoms such as pyridyloxy, pyrazyloxy, pyrimidyloxy and quinolyloxy ligands), alkylthio ligands (preferably having from 1 to 30 carbon atoms, still preferably from 1 to 20 carbon atoms and particularly preferably from 1 to 12 carbon atoms such as a methylthio ligand and an ethylthio ligand), arylthio ligands (preferably having from 6 to 30 carbon atoms, still preferably from 6 to 20 carbon atoms and particularly preferably from 6 to 12 carbon atoms such as a phenylthio ligand), heteroarylthio ligands (preferably having from 1 to 30 carbon atoms, still preferably from 1 to 20 carbon atoms and particularly preferably from 1 to 12 carbon atoms such as pyridylthio, 2-benzimidazolylthio, 2-benzoxazolylthio and 2-benzthiazolylthio ligands) and siloxy ligands (preferably having from 1 to 30 carbon atoms, still preferably from 3 to 25 carbon atoms and particularly preferably from 6 to 20 carbon atoms such as a triphenylsiloxy ligand, a triethoxysiloxy ligand and a triisopropylsiloxy ligand). Still preferable examples thereof include nitrogen-containing heterocyclic ligands, aryloxy ligands, heteroaryloxy ligands and siloxy ligands and nitrogen-containing heterocyclic ligands, aryloxy ligands, and siloxy ligands are still preferred.

The luminescent material in the light-emitting layer to be used in the present invention is not particularly restricted, so long as its ionization potential and electron affinity satisfy the above-described relationships. For example, use can be made of the following materials.

The luminescent material in the invention may be either a fluorescent compound emitting light from singlet excitons or a phosphorescent compound emitting light from triplet excitons. Examples thereof include benzoxazole derivatives, benzoimidazole derivatives, benzothiazole derivatives, styrylbenzene derivatives, polyphenyl derivatives, diphenylbutadiene derivatives, tetraphenylbutadiene derivatives, naphthalimide derivatives, coumalin derivatives, condensed aromatic compounds, perinone derivatives, oxadiazole derivatives, oxadine derivatives, aldazine derivatives, pyrralidine derivatives, cyclopentadiene derivatives, bisstyrylanthracene derivatives, bis-styryl anthracene derivatives, quinacridone derivatives, pyrrolopyridine derivatives, thiadiazolopyridine derivatives, styrylamine derivatives, diketopyrrolopyrrole derivatives, aromatic dimethylidyne compounds, various metal complexes typified by metal complexes, rare earth element complexes or transition metal complexes of 8-quinolinol derivatives and pyrromethene derivatives, polymer compounds such as polythiophene, polyphenylene and polyphenylene vinylene derivatives, organic silane derivatives and compounds according to the invention.

Preferable examples of the luminescent material in the invention include condensed aromatic compounds, styryl compounds, diketopyrrolopyrrole compounds, oxazine compounds, pyrromethene metal complexes, transtition metal complexes and lanthanoid complexes. Preferable examples of the condensed aromatic hydrocarbon compounds include naphthacene, pyrene chrysene, triphenylene, benzo[c]phenanthrene, benzo[a]anthracene, pentacene, perylene, fluoranthene, acenaphtho-fluoranthene, dibenzo[a,j]anthracene, dibenzo[a,h]anthracene, benzo[a]naphthacene, hexacene, anthanthrene and so on. Examples of the condensed aromatic heterocycles include naphtho[2,1-f]isoquinoline, α-naphtha-phenanthridine, phenanthroxazole, quinolino[6,5-f]quinoline, benzothiophanthrene and so on. These compounds may have substituent(s) such as aryl groups, heterocyclic aromatic rings, diarylamino groups or alkyl groups.

In the invention, the light-emitting layer contains the hole-transporting material in an amount of preferably from 1% by weight to 99% by weight, still preferably from 5% by weight to 90% by weight and still preferably from 10% by weight to 80% by weight.

In the invention, the light-emitting layer contains the electron-transporting material in an amount of preferably from 1% by weight to 99% by weight, still preferably from 5% by weight to 90% by weight and still preferably from 10% by weight to 80% by weight.

In the invention, the light-emitting layer contains the luminescent material in an amount of preferably from 0.01% by weight to 50% by weight, still preferably from 0.1% by weight to 30% by weight.

The weight ratio of the hole-transporting material to the electron-transporting material in the light-emitting layer preferably ranges from 5:100 to 100:5, still preferably from 1:10 to 10:1 and still preferably from 1:5 to 5:1.

The weight ratio of the sum of the hole-transporting material and the electron-transporting material to the luminescent material in the light-emitting layer preferably ranges from 100:0.01 to 100:50, still preferably from 100:0.1 to 100:30.

To conduct a preferable embodiment of the invention, it is preferable that the ionization potential of the electron-transporting material to be used in the electron-transporting layer in the invention satisfies the above-described relationship, though it is not particularly restricted. For example, use may be made of the following materials therefor.

Namely, examples thereof include triazole derivatives, oxazole derivatives, oxadiazole derivatives, fluorenone derivatives, anthraquinodimethane derivatives, anthrone derivatives, diphenylquinone derivatives, thiopyran dioxide derivatives, carbodiimide derivatives, fluorenylidene methane derivatives, distyrylpyrazine derivatives, heterocyclic tetracarboxylic anhydrides such as naphthalene and perylene, phthalocyanine derivatives, various metal complexes typified by metal complexes of 8-quinollinol derivatives, metallo-phthalocyanines and metal complexes having benzoxazole or benzothiazole as a ligand and so on.

Among all, an aromatic heterocyclic compound having one or more hetero atoms in its molecule is preferred.

Among the above-described compounds, the electron-transporting material to be used in the invention preferably has an azole skeleton. A compound having an azole skeleton means a compound having a heterocyclic skeleton having two or more hetero atoms other than carbon and hydrogen atoms in its fundamental skeleton. It may consist of either a monocycle or condensed rings. The heterocyclic skeleton is preferably a heterocycle having two or more atoms selected from among N, O and S atoms, still preferably an aromatic heterocycle having at least one N atom in its skeleton and particularly preferably an aromatic heterocycle having two or more N atoms in its skeleton. The hetero atom may be located either at a condensed position or a non-condensed position.

Examples of compounds containing two or more hetero atoms include pyrazole, imidazole, pyrazine, pyrimidine, indazole, purine, phthalazine, naphthylidine, quinoxaline, quinazoline, cinnoline, pteridine, perimidine, phenanthroline, pyrroloimidazole, pyrrolotriazole, pyrazoloimidazole, pyrazolotriazole, pyrazolopyrimidine, pyrazolotriazine, imidazoimidazole, imidazopyridazine, imidazopyridine, imidazopyrazine, triazolopyridine, benzimidazole, naphthoimidazole, benzoxazole, naphthoxazole, benzothiazole, naphthothiazole, benzotriazole, tetrazaindene, triazine, and so on. Preferable examples are compounds having a condensed azole skeleton or compounds having a triazine skeleton such as imidazopyridazine, imidazopyridine, imidazopyrazine, benzimidazole, naphthoimidazole, benzoxazole, naphthoxazole, benzothiazole and naphthothiazole. Imidazopyridine is particularly preferred.

The compounds having an azole skeleton are preferably compounds represented by the following formula (3).

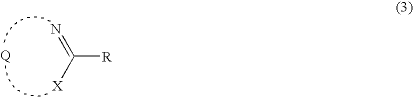

In the above formula (3), R represents a hydrogen atom or a substituent. The substituent is selected from the above-described substituent group A.

X represents O, S or N—R^{a} (wherein R^{a} represents a hydrogen atom, an aliphatic hydrocarbon group (for example, a methyl group, an ethyl group, an n-propyl group, an i-propyl group, an n-butyl group or an i-butyl group), an aryl group (for example, a phenyl group, a tolyl group, a naphthyl group or an anthranyl group) or a heterocyclic group (for example, a thienyl group, an imidazolyl group or a pyridyl group)).

Q represents an atomic group needed in binding to N and X to form a heterocycle.

If possible, R and X or R and Q are bonded together to form a ring.

Next, preferable specific examples of the electron-transporting material in the electron-transporting layer to be used in the invention will be shown, though the invention is not restricted thereto.

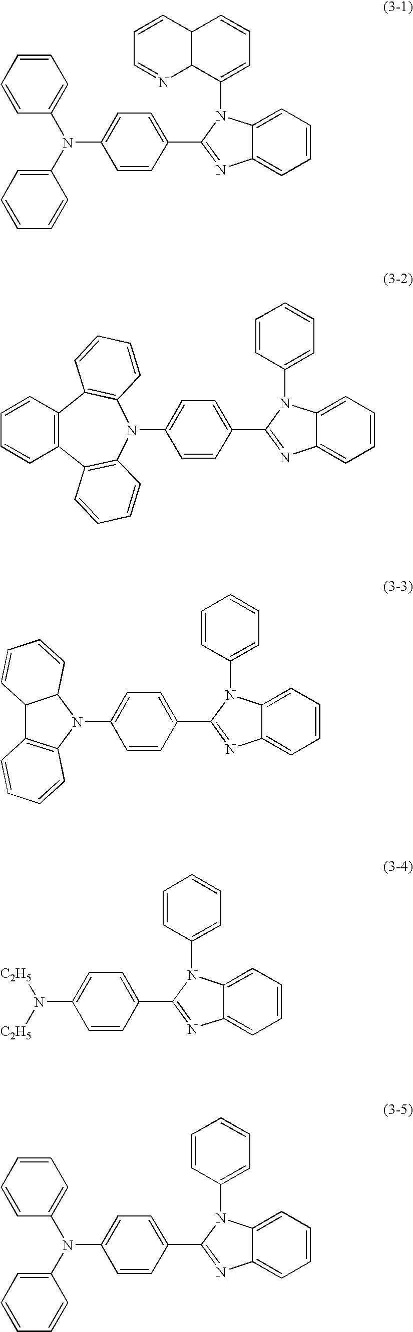

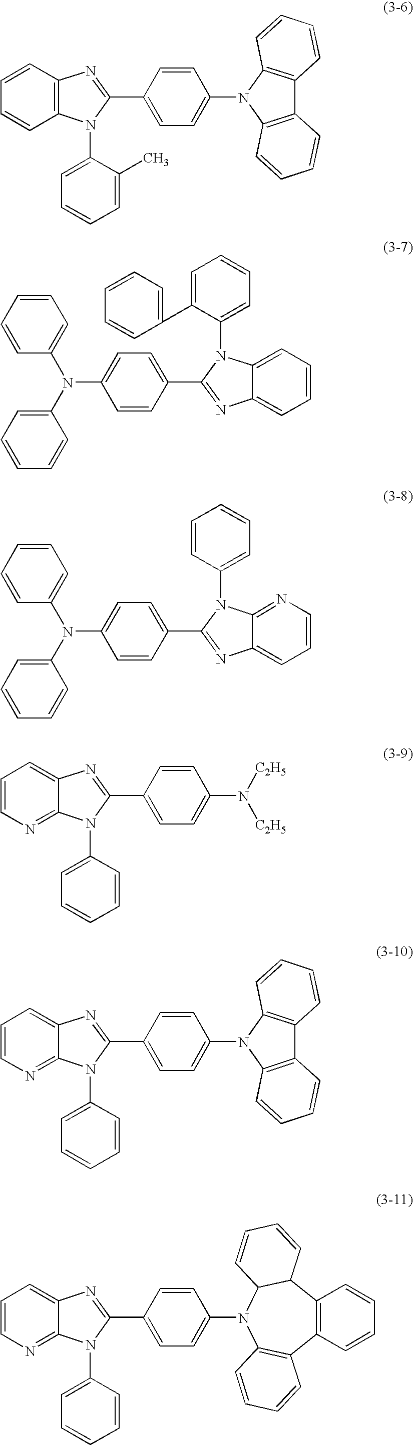

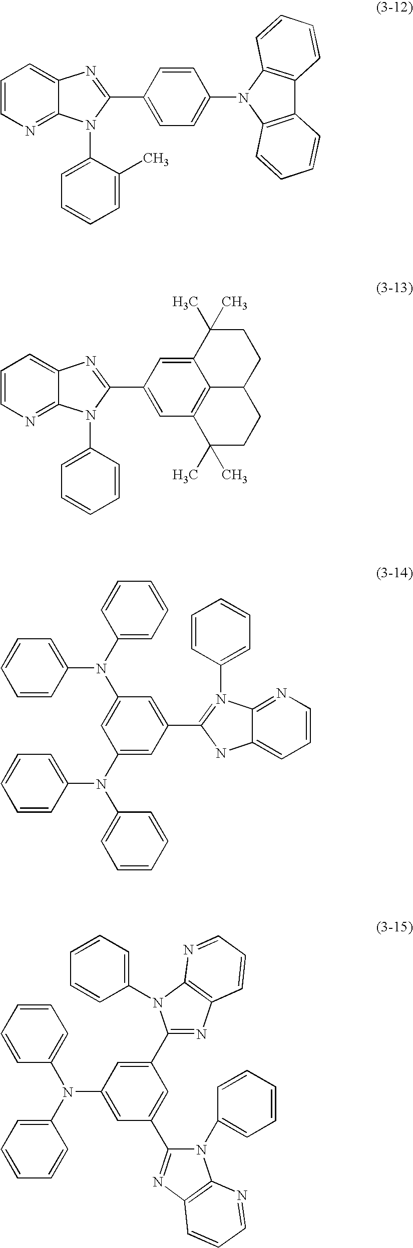

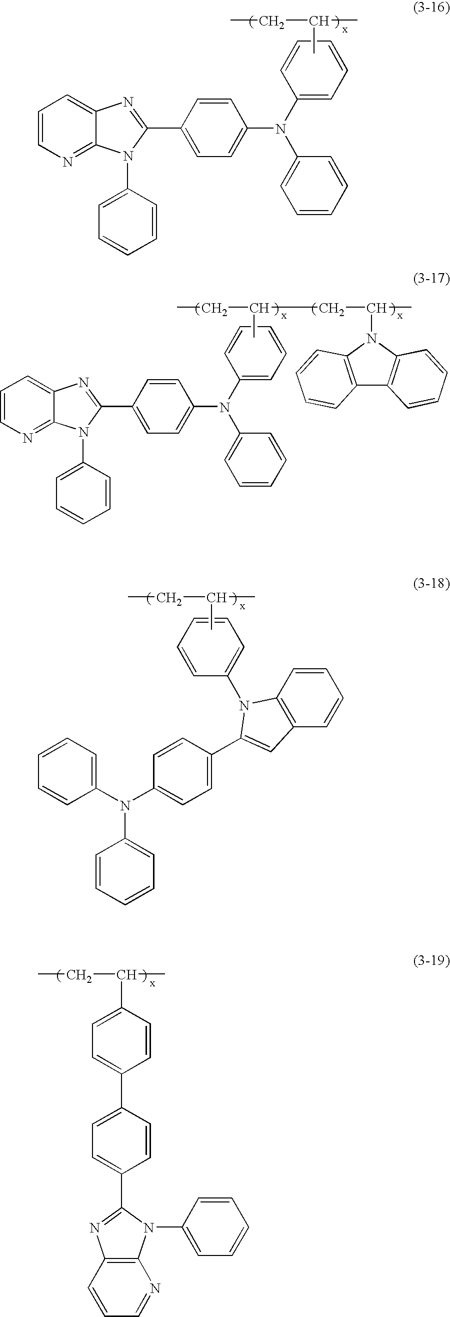

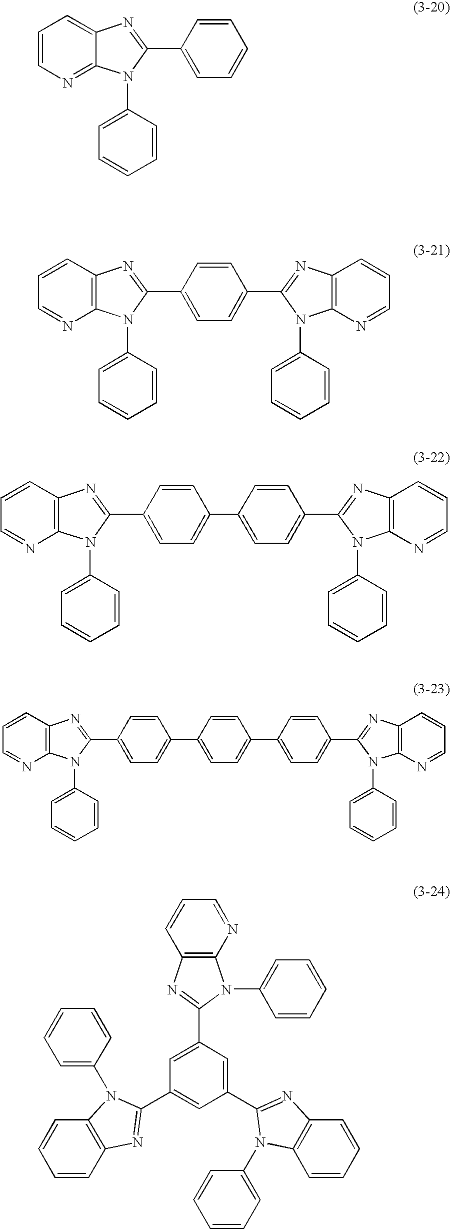

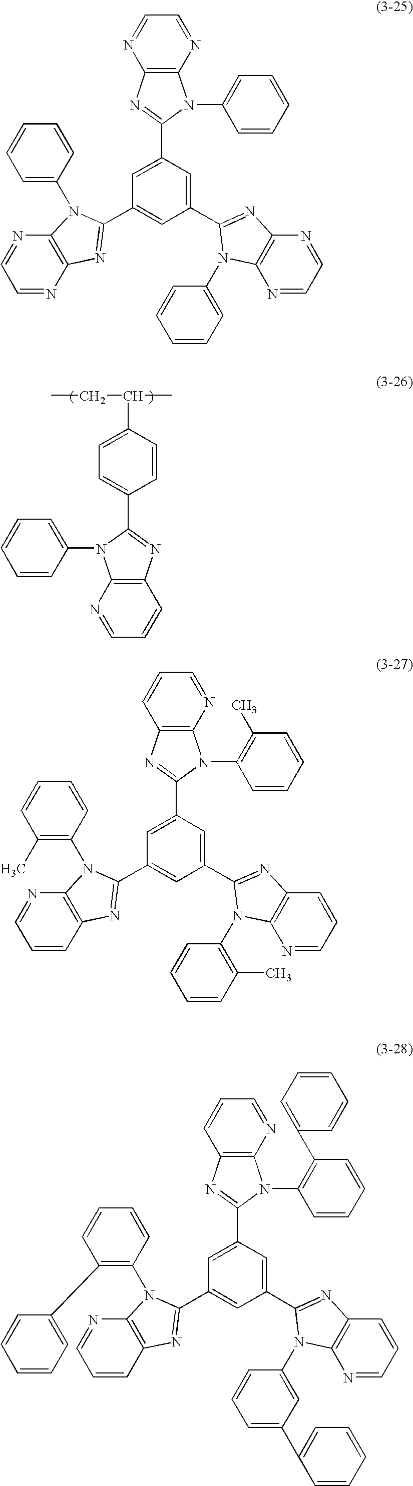

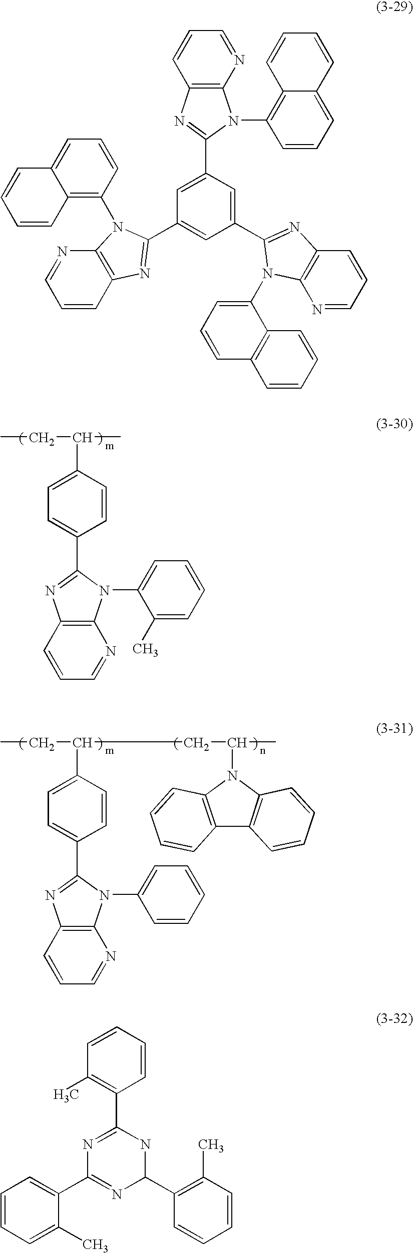

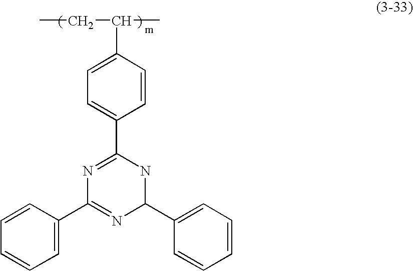

The compounds represented by the formula (3) to be used in the invention can be synthesized by reference to methods reported by JP-B-44-23025, JP-B-48-8842, JP-A-53-6331, JP-A-10-92578, US Patents 3,449,255and5,766,779, J. Am. Chem. Soc., 94, 2414 (1972), Helv. Chim. Acta, 63, 413 (1980), Liebigs Ann. Chem., 1423 (1982), and so on.

Next, the organic electroluminescent device according to the invention will be illustrated in greater detail.

Substrate

In the invention, it is preferable to use a substrate not scattering or attenuating the light emitted by the light-emitting layer. Specific examples of such materials include inorganic substances, such as yttrium-stabilized zirconia (YSZ) and glass, and organic substances, such as polyesters, e.g., polyethylene terephthalate, polybutylene phthalate, and polyethylene naphthalate, polystyrene, polycarbonate, polyether sulfone, polyarylate, polyimide, polycycloolefins, norbornene resins and polychlorotrifluoroethylene. In using an organic material, it is advisable to select one excellent in heat resistance, dimensional stability, solvent resistance, electrical insulating properties and processability.

The shape, structure, and size of the substrate are not particularly limited and selected appropriately according to the intended use or purpose of the device. In general, the substrate has a plate shape and may have either a single layer structure or a multilayer structure. It may be made of a single member or two or more members.

The substrate may be either colorless and transparent or colored and transparent, though a colorless and transparent substrate is preferred from the viewpoint of preventing the light emitted by the light-emitting layer from scattering or attenuation.

The substrate may have a moisture barrier layer (or a gas barrier layer) formed on the front face or the back face (the transparent electrode side) thereof.

Suitable materials for forming the moisture barrier layer (the gas barrier layer) include inorganic substances such as silicon nitride and silicon oxide. The moisture barrier layer (the gas barrier layer) can be formed by, for example, RF sputtering.

If desired, the substrate made of a thermoplastic resin may further have a hard coat layer, an undercoat layer, etc. formed thereon.

Organic Layer

The organic layer of the invention comprises at least one light-emitting layer.

Structure of Organic Layer

The organic layer may be formed in an any part of the organic electroluminescent device according to the invention selected appropriately according to the intended use or purpose of the device without particular restriction. It is preferable to form the organic layer on the transparent electrode (preferably the anode) or on the back electrode (preferably the cathode). In such a case, the organic layer is formed on the front face of the transparent electrode or the back electrode or all over the same.

The shape, size, thickness, etc. of the organic layer are not particularly restricted but selected appropriately according to the intended use or purpose of the device.

Specific examples of the layer structure of the organic electroluminescent device according to the invention including the organic layer are as follows: anode/light-emitting layer/cathode, anode/light-emitting layer/electron-transporting layer/cathode, anode/hole-transporting layer/light-emitting layer/electron-transporting layer/cathode, anode/hole-transporting layer/light-emitting layer/cathode, anode/light-emitting layer/electron-transporting layer/electron-injecting layer/cathode, anode/hole-injecting layer/hole-transporting layer/light-emitting layer/electron-transporting layer/electron-injecting layer/cathode, and so on. Among all, it is preferable that the organic layers comprise at least the hole-transporting layer, the light-emitting layer and the electron-transporting layer from the viewpoints of durability and luminescence efficiency.

It is appropriate to use a hole-transporting material in the hole-transporting layer and the hole-injecting layer. It is also appropriate to use an electron-transporting material in the electron-transporting layer and the electron-injecting layer. As the hole-transporting material and the electron-transporting material, use can be made of the materials cited above with respect to the light-emitting layer.

Formation of Organic Layer

The organic layers can be formed by dry film formation techniques such as vacuum deposition and sputtering, wet film formation techniques such as dipping, spin coating, dip coating, casting, die coating, roll coating, bar coating, and gravure coating, transferring, printing or the like.

Anode

The anode is, generally, not limited in shape, structure, size, etc. as long as the function as an anode (to supply positive holes to the organic layer) is fulfilled. The anode is selected appropriately from among known electrodes according to the use and purpose of the organic electroluminescent device.

Suitable materials of the transparent anode include metals, alloys, metal oxides, organic conductive compounds, and mixtures thereof. Those having a work function of 4.0 eV or more are preferred. Specific examples of these materials include semiconductive metal oxides, such as tin oxide doped with antimony, fluorine, etc. (e.g., ATO or FTO), tin oxide, zinc oxide, indium oxide, indium tin oxide (ITO), and indium zinc oxide (IZO); metals, such as gold, silver, chromium, and nickel; mixtures or composite laminates composed of these metals and conductive metal oxides; inorganic conductive substances, such as copper iodide and copper sulfide; organic conductive materials, such as polyaniline, polythiophene, and polypyrrole; and composite laminates composed of these materials and ITO.

The anode can be formed on the organic layer by a process properly selected according to suitability to the material from among wet processes such as printing and coating, physical processes such as vacuum deposition, sputtering and ion plating, and chemical processes such as CVD and plasma CVD. In the case of selecting ITO as the anode material, for instance, the anode can be formed by DC sputtering, RF sputtering, vacuum deposition, or ion plating. In the case of selecting an organic conductive compound as the anode material, the anode can be formed by a wet film forming method.

The anode may be formed in any part of the organic electroluminescent device according to the invention selected appropriately according to the intended use or purpose of the device without particular restriction. It is preferable to form the anode on the substrate. In such a case, the anode may be formed in a part of one face of the substrate or all over the same.

Methods of patterning the anode include chemical etching by photolithography or like techniques and physical etching with a laser beam, etc. Otherwise, the anode can be formed by vacuum deposition, sputtering or a like dry film formation process through a pattern mask, or by a lift-off method or a printing method.

The thickness of the anode cannot be generally specified, being subject to variation depending on the material. Usually, the thickness is 10 nm to 50 μm, preferably 50 nm to 20 μm.

The anode preferably has a resistivity of 10³ Ω/□ (Ω/square) or less, preferably 10² Ω/□ or less.

In order to obtain light output from the anode side, it is preferable that the anode is transparent. The transmission of the-anode is preferably 60% or higher, still preferably 70% or higher. The transmission is measured by a publicly known method with the use of a spectrophotometer. In this case, the anode may be colorless and transparent or colored and transparent.

Detailed illustration on anodes is given in Tomei Denkyokumaku no Shintenkai, supervised by Yutaka Sawada, CMC (1999) which is applicable to the invention. In the case of using a plastic base having low heat resistance, it is desirable to employ ITO or IZO and from an anode film at a low temperature of 150° C. or below.

Cathode

The cathode is usually not limited in shape, structure and size as long as the function of injecting electrons into the organic layer is fulfilled. The shape, structure, and size are appropriately chosen from known electrode designs according to the intended use or purpose of the device.

Materials making up the cathode include metals, alloys, metal oxides, electrically conductive compounds, and mixtures thereof. Those having a work function of 4.5 eV or less are preferred. Specific examples of such materials are alkali metals (e.g., Li, Na, K, and Cs), alkaline earth metals (e.g., Mg and Ca), gold, silver, lead, aluminum, sodium-potassium alloys, lithium-aluminum alloys, magnesium-silver alloys, and rare earth metals (e.g., indium and ytterbium). These materials can be used individually or as a combination of two or more thereof. A combined use is preferred for obtaining both stability and electron injection properties.

Alkali metals and alkaline earth metals are preferred from the aspect of electron injection, and aluminum-based materials are preferred from the aspect of storage stability.

The aluminum-based materials include aluminum and mixtures or alloys comprising aluminum and 0.01 to 10% by weight of an alkali metal or an alkaline earth metal, such as an aluminum-lithium alloy and an aluminum-magnesium alloy.

For more detailed information about the cathode materials, refer to JP-A-2-15595 and JP-A-5-121172.

The cathode can be formed by any known method with no particular restriction. Namely, it can be formed by a method properly selected according to suitability to the material from among wet processes such as printing and coating, physical processes such as vacuum deposition, sputtering and ion plating, and chemical processes such as CVD and plasma CVD. In the case of selecting a metal etc. as the cathode material, for instance, the cathode may be formed by simultaneously or successively sputtering one or more such materials.

Methods of patterning the cathode include chemical etching by photolithography and like techniques and physical etching with a laser beam, etc. Otherwise, the cathode can be formed by vacuum deposition, sputtering or a like thin film formation technique through a pattern mask, or by a lift-off method or a printing method.

The cathode may be formed in any part of the organic electroluminescent device according to the invention selected appropriately according to the intended use or purpose of the device without particular restriction. It is preferable to form the cathode on the organic layer. In such a case, the cathode may be formed in a part of the organic layer or all over the same.

A dielectric layer made of, for example, a fluoride of an alkali metal or an alkaline earth metal may be formed between the cathode and the organic layer to a thickness of 0.1 to 5 nm.

The dielectric layer can be formed by, for example, vacuum deposition, sputtering or ion plating.

The thickness of the cathode is subject to variation depending on the material and cannot be generally specified. Usually, the thickness is 10 nm to 5 μm, preferably 50 nm to 1 μm.

The cathode may be either transparent or opaque. A transparent cathode can be formed by forming a thin film (thickness: 1 to 10 nm) of a cathode material and laminating a transparent conductive material such as ITO or IZO as described above thereon.

A moisture absorber or an inert liquid may be disposed in the space between a sealing container and the organic electroluminescent device. The moisture absorber includes, but is not limited to, barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeolite and magnesium oxide and so on. The inert liquid includes, but is not limited to, paraffins, liquid paraffins, fluorine-containing solvents, such as perfluoroalkanes, perfluoroamines and perfluoroethers, chlorine-containing solvents, silicone oils and so on.

The organic electroluminescent device of the invention emits light on applying a DC (which may contain, if desired, an alternating component) voltage (usually 2 to 40 V) or a DC current between the anode and the cathode.

For driving the organic electroluminescent device of the invention, the methods described in JP-A-2-148687, JP-A-6-301355, JP-A-5-29080, JP-A-7-134558, JP-A-8-234685, JP-A-8-241047, U.S. Pat. Nos. 5,828,429 and 6,0233,308, and Japanese Patent 2784615 can be made use of.

The organic electroluminescent device according to the invention is effectively usable as a planar light source of full color displays, backlights, lighting equipment, and as a light source array for printers and the like.

### EXAMPLES

The present invention will now be illustrated in greater detail with reference to Examples of the organic electroluminescent device according to the invention, but it should be understood that the invention is not deemed to be limited thereto.

### Example 1

### Example 1-1

<Construction of Organic Electroluminescent Device Sample>

An ITO thin film (thickness: 0.2 μm) was formed as an anode on a 2.5 cm side square cut out of a 0.5 mm thick glass substrate by DC magnetron sputtering using an ITO target having an In₂O₃ content of 95% by weight (substrate temperature: 100° C., oxygen partial pressure: 1×10⁻³ Pa). The surface resistivity of the ITO thin film was 10 Ω/□.

Next, the substrate having the above-described anode formed thereon was put into a washing container, IPA-washed and then treated with UV-ozone for 30 minutes.

On this anode, a hole-injecting layer of 0.01 μm in thickness was formed by vacuum depositing copper phthalocyanine at a speed of 1 nm/sec. Further, a hole-transporting layer of 0. 05 μm in thickness was formed thereon by vacuum depositing N,N′-dinaphthyl-N,N′-diphenylbenzen at a speed of 1 nm/sec.

On this hole-transporting layer, the above-described compound (1-1) as a hole-transporting material, Alq₃ (tris(8-hydroxyquinolinato)aluminum) as an electron-transporting material and rubrene as a luminescent material were co-deposited by vacuum deposition at a ratio of 50/50/1 to give a light-emitting layer of 0.04 μm in thickness.

Moreover, Alq₃ was deposited thereon by vacuum deposition at a speed of 1 nm/sec to give an electron-transporting layer of 0.02 μm in thickness.

Further, a patterned mask (a mask giving a light-emitting area of 5 mm×5 mm) was provided on the electron-transporting layer and an electron-injecting layer of 0.001 μm in thickness was formed by vacuum depositing lithium fluoride. A cathode of 0.15 μm was formed thereon by vacuum depositing aluminum.

An aluminum lead was connected to each of the anode and the cathode to form a light-emitting laminate.

The resulting product was put in a glove box purged with argon gas and sealed into a stainless container with a UV-curing adhesive (XNR 5516HV, available from Nagese-CIBA Ltd.) to thereby give an organic electroluminescent device according to the invention.

<Evaluation of Organic Electroluminescent Device Sample>

The resulting organic electroluminescent device was evaluated as follows.

A DC voltage was applied to the organic electroluminescent device by using a Source-Measure Unit Model 2400 supplied by Toyo Corp., and the maximum luminance Lₘₐₓ and the voltage Vₘₐₓ for obtaining the Lₘₐₓ were recorded. The luminescence efficiency at 200 cd/m² (η₂₀₀) was obtained. The results are shown in Table 1.

Using this organic electroluminescent device, a continuous driving test was conducted under such conditions as giving an initial luminance of 2000 Cd/m² and the time required until the luminance reached 1000 Cd/m² was referred to as the luminance half-life T(½). The results are shown in Table 1.

Ionization potentials were measured by using a UV photoelectron analyzer AC-1 supplied by Riken Keiki. Electron affinities were each determined by subtracting absorption end energy of absorption spectrum from the above-described ionization potential.

The ionization potentials and the electron affinities of the hole-transporting material (compound 1-1), the electron-transporting material (Alq₃) and the luminescent material (rubrene) employed in the light-emitting layer of this EXAMPLE are as follows.

| | Ionization | Electron |
|---|---|---|
| | potential (eV) | affinity (eV) |
| Compound (1-1) | 5.7 (Ip (HL)) | 2.5 (Ea (HL)) |
| Alq₃ | 5.8 (Ip (EL)) | 2.8 (Ea (EL)) |
| Rubrene | 5.4 (Ip (L)) | 2.9 (Ea (L)) |

In this EXAMPLE, the following relationships were satisfied:
Ip (L)≦IP (HL)≦Ip (EL); and
Ea (L)≧Ea (EL)≧Ea (HL).

### Comparative Example 1

An organic electroluminescent device was constructed by the same method as in EXAMPLE 1-1 but using the compound (2) represented by the following formula as a substitute for the compound (1-1) employed as the hole-transporting material in the light-emitting layer in EXAMPLE 1-1. Then the resulting organic electroluminescent device was evaluated. The results are shown in Table 1.

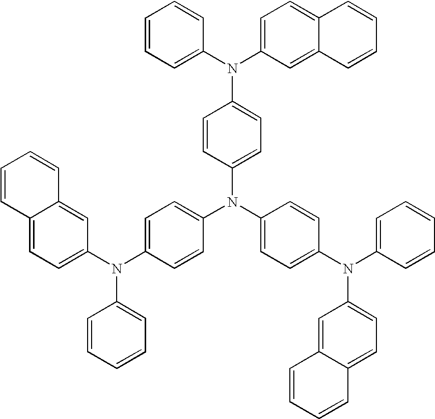

The ionization potentials and the electron affinities of materials employed in the light-emitting layer of this COMPARATIVE EXAMPLE are as follows.

| | Ionization | Electron |
|---|---|---|
| | potential (eV) | affinity (eV) |
| Compound (2) | 5.2 (Ip (HL)) | 2.3 (Ea (HL)) |
| Alq₃ | 5.8 (Ip (EL)) | 2.8 (Ea (EL)) |
| Rubrene | 5.4 (Ip (L)) | 2.9 (Ea (L)) |

In this COMPARTIVE EXAMPLE, wherein the relationship Ip (L)≦IP (HL)≦Ip (EL) is not satisfied, a low luminescence efficiency and a largely worsened durability were observed as shown in Table 1.

### Example 1-2

An organic electroluminescent device was constructed by the same method as in EXAMPLE 1-1 but using PBD (2-(4-biphenylyl)-5-(4-t-butylphenyl)-1,3,4-oxadiazole) as a substitute for Alq₃ employed as the electron-transporting material in the light-emitting layer in EXAMPLE 1-1. Then the resulting organic electroluminescent device was evaluated. The results are shown in Table 1.

The ionization potentials and the electron affinities of materials employed in the light-emitting layer of this EXAMPLE are as follows.

| | Ionization | Electron |
|---|---|---|
| | potential (eV) | affinity (eV) |
| Compound (1-1) | 5.7 (Ip (HL)) | 2.5 (Ea (HL)) |
| PBD | 5.8 (Ip (EL)) | 3.0 (Ea (EL)) |
| Rubrene | 5.4 (Ip (L)) | 2.9 (Ea (L)) |

The organic electroluminescent device in this EXAMPLE, wherein the relationship Ea (L)≧Ea (EL)≧Ea (HL) is not satisfied, was inferior to the organic electroluminescent device according to the invention satisfying the relationship Ea (L)≧Ea (EL)≧Ea (HL) but showed an elevated luminescence efficiency, an elevated luminance and an improved durability compared with the organic electroluminescent device of COMPARATIVE EXAMPLE 1 not satisfying the relationship Ip (L)≦IP (HL)≦Ip (EL), as shown in Table 1.

### Example 1-3

An organic electroluminescent device was constructed by the same method as in EXAMPLE 1-1 but using the above-described compound (1-9) represented by the following formula as a substitute for the compound (1-1) employed as the hole-transporting material in the light-emitting layer in EXAMPLE 1-1. Then the resulting organic electroluminescent device was evaluated. The results are shown in Table 1.

The ionization potentials and the electron affinities of materials employed in the light-emitting layer of this EXAMPLE are as follows.

| | Ionization | Electron |
|---|---|---|
| | potential (eV) | affinity (eV) |
| Compound (1-9) | 5.6 (Ip (HL)) | 2.5 (Ea (HL)) |
| Alq₃ | 5.8 (Ip (EL)) | 2.8 (Ea (EL)) |
| Rubrene | 5.4 (Ip (L)) | 2.9 (Ea (L)) |

### Example 1-4

An organic electroluminescent device was constructed by the same method as in EXAMPLE 1-1 but using the above-described compound (1-25) represented by the following formula as a substitute for the compound (1-1) employed as the hole-transporting material in the light-emitting layer in EXAMPLE 1-1. Then the resulting organic electroluminescent device was evaluated. The results are shown in Table 1.

The ionization potentials and the electron affinities of materials employed in the light-emitting layer of this EXAMPLE are as follows.

| | Ionization | Electron |
|---|---|---|
| | potential (eV) | affinity (eV) |
| Compound (1-25) | 5.5 (Ip (HL)) | 2.5 (Ea (HL)) |
| Alq₃ | 5.8 (Ip (EL)) | 2.8 (Ea (EL)) |
| Rubrene | 5.4 (Ip (L)) | 2.9 (Ea (L)) |

### Example 1-5

An organic electroluminescent device was constructed by the same method as in EXAMPLE 1-1 but using the above-described compound (1-42) represented by the following formula as a substitute for the compound (1-1) employed as the hole-transporting material in the light-emitting layer in EXAMPLE 1-1. Then the resulting organic electroluminescent device was evaluated. The results are shown in Table 1.

The ionization potentials and the electron affinities of materials employed in the light-emitting layer of this EXAMPLE are as follows.

| | Ionization | Electron |
|---|---|---|
| | potential (eV) | affinity (eV) |
| Compound (1-42) | 5.5 (Ip (HL)) | 2.4 (Ea (HL)) |
| Alq₃ | 5.8 (Ip (EL)) | 2.8 (Ea (EL)) |
| Rubrene | 5.4 (Ip (L)) | 2.9 (Ea (L)) |

### Example 1-6

An organic electroluminescent device was constructed by the same method as in EXAMPLE 1-1 but using-the above-described compound (1-58) represented by the following formula as a substitute for the compound (1-1) employed as the hole-transporting material in the light-emitting layer in EXAMPLE 1-1. Then the resulting organic electroluminescent device was evaluated. The results are shown in Table 1.

The ionization potentials and the electron affinities of materials employed in the light-emitting layer of this EXAMPLE are as follows.

| | Ionization | Electron |
|---|---|---|
| | potential (eV) | affinity (eV) |
| Compound (1-42) | 5.5 (Ip (HL)) | 2.4 (Ea (HL)) |
| Alq₃ | 5.8 (Ip (EL)) | 2.8 (Ea (EL)) |
| Rubrene | 5.4 (Ip (L)) | 2.9 (Ea (L)) |

TABLE 1

| | Lₘₐₓ | Vₘₐₓ | η₂₀₀ | T(½) |
|---|---|---|---|---|
| | (Cd/m²) | (V) | (%) | (hour) |
| Ex. 1-1 | 76000 | 12 | 4.2 | 5500 |
| Comp. Ex. 1 | 28000 | 10 | 0.4 | 350 |
| Ex. 1-2 | 47000 | 12 | 1.1 | 1800 |
| Ex. 1-3 | 62000 | 12 | 2.8 | 4600 |
| Ex. 1-4 | 78000 | 12 | 3.2 | 4800 |
| Ex. 1-5 | 72000 | 12 | 3.0 | 4500 |
| Ex. 1-6 | 68000 | 12 | 2.8 | 4600 |

The results given in Table 1 indicate that a device the ionization potentials of the hole-transporting material, the electron-transporting material and the luminescent material in the light-emitting layer of which satisfy the above ionization potential relationship is superior in luminescence efficiency, luminance and durability to the device of COMPARATIVE EXAMPLE not satisfying the above-described relationships. It is also indicated that each performance can be largely improved in the case where the above ionization potential relationship is satisfied and the above electron affinity relationship is also satisfied.

### Example 2

### Example 2-1

An ITO thin film (thickness: 0.2 μm) was formed as an anode, and a hole-injecting layer made of copper phthalocyanine and a hole-transporting layer made of N,N′-dinaphthyl-N,N′-diphenylbenzene (NPD) were formed thereon each in the same manner as in EXAMPLE 1. The obtained product was used in constructing an organic electroluminescent device sample as described below.

On this sample provided with a hole-transporting layer, the above-described compound (1-1) as a hole-transporting material, Alq3 (tris(8-hydroxyquinolinato)aluminum) as an electron-transporting material and rubrene as a luminescent material were co-deposited by vacuum deposition at a ratio of 50/50/1 to give a light-emitting layer of 0.04 μm in thickness. Moreover, the above-described compound (3-27) was deposited thereon by vacuum deposition at a speed of 1 nm/sec to give an electron-transporting layer of 0.02 μm in thickness.

Further, a patterned mask (a mask giving a light-emitting area of 5 mm×5 mm) was provided on the electron-transporting layer and an electron-injecting layer of 0.001 μm in thickness was formed by vacuum depositing lithium fluoride. A cathode of 0.15 μm was formed thereon by vacuum depositing aluminum.

An aluminum lead was connected to each of the anode and the cathode to form a light-emitting laminate.

The resulting product was put in a glove box purged with argon gas and sealed into a stainless container with a UV-curing adhesive (XNR 5516HV, available from Nagese-CIBA Ltd.) to thereby give an organic electroluminescent device according to the invention.

The ionization potentials of the hole-transporting material in the hole-transporting layer (HH), the hole-transporting material in the light-emitting layer (HL), the electron-transporting material in the light-emitting layer (EL) and the electron-transporting material in the electron-transporting layer (EE) are shown in Table 2. These ionization potentials were measured by using a UV photoelectron analyzer AC-1 supplied by Riken Keiki.

A DC voltage was applied to the organic electroluminescent device by the same method as in EXAMPLE 1 and the maximum luminance L. and the voltage V. for obtaining the Lo were recorded. The luminescence efficiency at 200 cd/m² (η₂₀₀) was obtained. The results are shown in Table 2.

This organic electroluminescent device was subjected to the same continuous driving test as in EXAMPLE 1 under such conditions as giving an initial luminance of 2000 Cd/m² and the time needed until the luminance reached 1000 Cd/m² was referred to as the luminance half-life T(1/2). The results are shown in Table 2.

### Example 2-2

An organic electroluminescent device was constructed by the same method as in EXAMPLE 2-1 but using the compound (3-28) as a substitute for the compound (3-27) employed as the electron-transporting material in the electron-transporting layer in EXAMPLE 2-1. Then the organic electroluminescent device was evaluated. The results are shown in Table 2.

### Example 2-3

An organic electroluminescent device was constructed by the same method as in EXAMPLE 2-1 but using the compound (3-24) as a substitute for the compound (3-27) employed as the electron-transporting material in the electron-transporting layer in EXAMPLE 2-1. Then the organic electroluminescent device was evaluated. The results are shown in Table 2.

### Example 2-4

An organic electroluminescent device was constructed by the same method as in EXAMPLE 2-1 but using the oxadiazole compound (4) represented by the following formula as a substitute for the compound (3-27) employed as the electron-transporting material in the electron-transporting layer in EXAMPLE 2-1. Then the organic electroluminescent device was evaluated. The results are shown in Table 2.

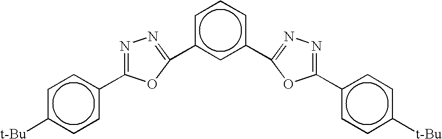

### Example 2-5

An organic electroluminescent device was constructed by the same method as in EXAMPLE 2-1 but using the above-described compound (1-2) as a substitute for the compound (1-1) employed as the hole-transporting material in the light-emitting layer in EXAMPLE 2-1. Then the organic electroluminescent device was evaluated. The results are shown in Table 2.

### Example 2-6

An organic electroluminescent device was constructed by the same method as in EXAMPLE 2-1 but using the above-described compound (1-25) as a substitute for the compound (1-1) employed as the hole-transporting material in the light-emitting layer in EXAMPLE 2-1. Then the organic electroluminescent device was evaluated. The results are shown in Table 2.

### Example 2-7

An organic electroluminescent device was constructed by the same method as in EXAMPLE 2-1 but using the above-described compound (1-39) as a substitute for the compound (1-1) employed as the hole-transporting material in the light-emitting layer in EXAMPLE 2-1. Then the organic electroluminescent device was evaluated. The results are shown in Table 2.

### Example 2-8

An organic electroluminescent device was constructed by the same method as in EXAMPLE 2-1 but using the above-described compound (1-50) as a substitute for the compound (1-1) employed as the hole-transporting material in the light-emitting layer in EXAMPLE 2-1. Then the organic electroluminescent device was evaluated. The results are shown in Table 2.

### Example 2-9

An organic electroluminescent device was constructed by the same method as in EXAMPLE 2-1 but using the anthracene compound (5) represented by the following formula as a substitute for the compound (1-1) employed as the hole-transporting material in the light-emitting layer in EXAMPLE 2-1. Then the organic electroluminescent device was evaluated. The results are shown in Table 2.

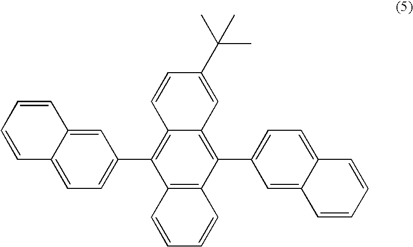

### Example 2-10

An organic electroluminescent device was constructed by the same method as in EXAMPLE 2-1 but using the anthracene compound (6) represented by the following formula as a substitute for the compound (1-1) employed as the hole-transporting material in the light-emitting layer in EXAMPLE 2-1. Then the organic electroluminescent device was evaluated. The results are shown in Table 2.

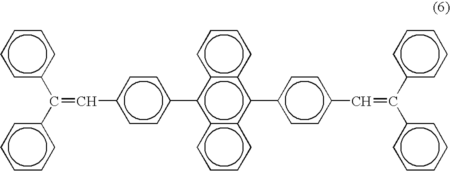

### Comparative Example 2

An organic electroluminescent device was constructed by the same method as in EXAMPLE 2-1 but using the arylamine compound (7) represented by the following formula as a substitute for the compound (1-1) employed as the hole-transporting material in the light-emitting layer in EXAMPLE 2-1. Then the organic electroluminescent device was evaluated. The results are shown in Table 2.

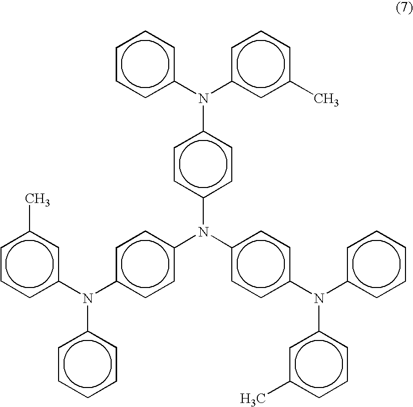

### Comparative Example 3

An organic electroluminescent device was constructed by the same method as in EXAMPLE 2-1 but using Alq₃ as a substitute for the compound (3-27) employed as the electron-transporting material in the electron-transporting layer in EXAMPLE 2-1. Then the organic electroluminescent device was evaluated. The results are shown in Table 2.

TABLE 2

| | Ip | Ip | Ip | Ip | | | | |
|---|---|---|---|---|---|---|---|---|
| | (HH) | (HL) | (EL) | (EE) | Lₘₐₓ | Vₘₐₓ | η₂₀₀ | T(½) |
| | (eV) | (eV) | (eV) | (eV9 | (Cd/m²) | (V) | (%) | (hour) |
| Ex. 2-1 | 5.4 | 5.7 | 5.8 | 6.3 | 76000 | 12 | 4.6 | 7800 |
| Ex. 2-2 | 5.4 | 5.7 | 5.8 | 6.4 | 68000 | 12 | 3.9 | 5200 |
| Ex. 2-3 | 5.4 | 5.7 | 5.8 | 6.2 | 67000 | 12 | 4.1 | 5500 |
| Ex. 2-4 | 5.4 | 5.7 | 5.8 | 6.0 | 62000 | 12 | 3.2 | 4600 |
| Ex. 2-5 | 5.4 | 5.6 | 5.8 | 6.3 | 78000 | 12 | 4.2 | 5800 |
| Ex. 2-6 | 5.4 | 5.6 | 5.8 | 6.3 | 75000 | 12 | 4.0 | 5500 |
| Ex. 2-7 | 5.4 | 5.7 | 5.8 | 6.3 | 78000 | 12 | 3.8 | 4600 |
| Ex. 2-8 | 5.4 | 5.6 | 5.8 | 6.3 | 68000 | 13 | 3.2 | 4200 |
| Ex. 2-9 | 5.4 | 5.6 | 5.8 | 6.3 | 89000 | 11 | 3.9 | 6200 |
| Ex. 2-10 | 5.4 | 5.6 | 5.8 | 6.3 | 78000 | 12 | 4.1 | 6500 |
| C. Ex. 2 | 5.4 | 5.1 | 5.8 | 6.3 | 59000 | 10 | 1.4 | 390 |
| C. Ex. 3 | 5.4 | 5.7 | 5.8 | 5.8 | 54000 | 9 | 0.8 | 580 |

From the results shown in Table 2, it can be understood that the organic electroluminescent devices according to the invention each having ionization potentials of the hole-transporting materials in the hole-transporting layer and the light-emitting layer and the electron-transporting materials in the electron-transporting layer and the light-emitting layer satisfying the above relationships are highly superior in both of luminescence efficiency and durability to the devices of COMPARATIVE EXAMPLES not satisfying the ionization potential relationships as defined above.

This application is based on Japanese Patent application JP 2003-330995, filed Sep. 24, 2003, Japanese Patent application JP 2003-331516, filed Sep. 24, 2003, and Japanese Patent application JP 2004-233037, filed Aug. 10, 2004, the entire contents of which are hereby incorporated by reference, the same as if set forth at length.

1. An organic electroluminescent device comprising a pair of electrodes and at least one organic layer including a light-emitting layer between the pair of electrodes,
wherein the light-emitting layer contains a hole-transporting material, an electron-transporting material and a luminescent material; and
an ionization potential of the hole-transporting material, Ip (HL), an ionization potential of the electron-transporting material, Ip (EL), and an ionization potential of the luminescent material, Ip (L) satisfy the relationship:
Ip (L)≦IP (HL)≦Ip (EL).

2. The organic electroluminescent device of claim 1, wherein an electron affinity of the hole-transporting material, Ea (HL), an electron affinity of the electron-transporting material, Ea (EL), and an electron affinity of the luminescent material, Ea (L) satisfy the relationship:
Ea (L)≧Ea (EL)≧Ea (HL).

3. An organic electroluminescent device comprising:
a pair of electrodes; and
a hole-transporting layer containing a hole-transporting material, a light-emitting layer containing a hole-transporting material, an electron-transporting material and a luminescent material, and an electron-transporting layer containing an electron-transporting material, between the pair of electrodes,
wherein an ionization potential of the hole-transporting material contained in the hole-transporting layer, Ip (HH), an ionization potential of the hole-transporting material contained in the light-emitting layer, Ip (HL), and an ionization potential of the electron-transporting material contained in the light-emitting layer, Ip (EL), and an ionization potential of the electron-transporting material contained in the electron-transporting layer, Ip (EE) satisfy the relationship:
Ip (HH)≦IP (HL)≦Ip (EL)<Ip (EE).

4. The organic electroluminescent device of claim 3, wherein the ionization potential of the electron-transporting material contained in the light-emitting layer, Ip (EL), and the ionization potential of the electron-transporting material contained in the electron-transporting layer Ip (EE) satisfy the relationship:
Ip (EE)≧Ip (EL)+0.2 (eV).

5. The organic electroluminescent device of claim 3, wherein the electron-transporting material in the electron-transporting layer is an aromatic heterocyclic compound having at least one hetero atom in its molecule.

6. The organic electroluminescent device of claim 5, wherein the electron-transporting material in the electron-transporting layer is represented by the formula (3): 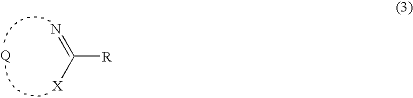
wherein R represents a hydrogen atom or a substituent; X represents O, S or N—R^{a}, in which R^{a} represents a hydrogen atom, an aliphatic hydrocarbon group, an aryl group or a heterocyclic group; Q represents an atomic group necessary to form a heterocycle by binding with N and X; and R and X or R and Q may be bonded to form a ring.

7. The organic electroluminescent device of claim 1, wherein the hole-transporting material contained in the light-emitting layer is a condensed aromatic compound.

8. The organic electroluminescent device of claim 1, wherein the hole-transporting material contained in the light-emitting layer is a condensed aromatic compound represented by the formula (1): 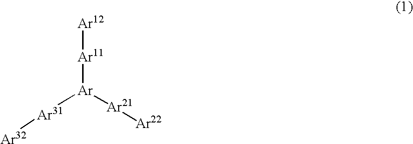
wherein Ar represents a polyvalent aromatic ring group; Ar¹¹, Ar²¹ and Ar³¹ each independently represent an arylene group; and Ar¹², Ar²² and Ar³² each independently represent a substituent or a hydrogen atom, provided that at least two of Ar¹¹, Ar²¹, Ar³¹, Ar¹², Ar²² and Ar³² are a tricyclic or higher condensed aromatic hydrocarbon ring or a tricyclic or higher condensed aromatic heterocycle.

9. The organic electroluminescent device of claims 3, wherein the hole-transporting material contained in the light-emitting layer is an anthracene compound represented by the formula (2): 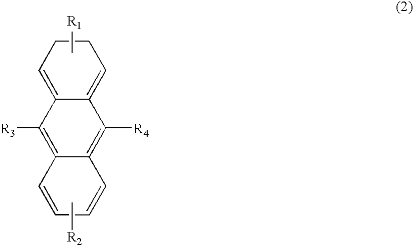
wherein R¹, R², R³ and R⁴ each independently represent an aryl group, an alkyl group having from 1 to 24 carbon atoms or a hydrogen atom.

10. The organic electroluminescent device of claim 1, wherein the electron-transporting material contained in the light-emitting layer is a metal complex compound.

11. The organic electroluminescent device of claim 3, wherein the electron-transporting material contained in the light-emitting layer is a metal complex compound.

12. The organic electroluminescent device of claim 10, wherein the metal complex compound contains Be, Mg, Al, Ga, Zn, In or Sn.

13. The organic electroluminescent device of claim 11, wherein the metal complex compound contains Be, Mg, Al, Ga, Zn, In or Sn.

14. The organic electroluminescent device of claim 10, wherein the metal complex compound contains Be, Al, Ga or Zn.

15. The organic electroluminescent device of claim 11, wherein the metal complex compound contains Be, Al, Ga or Zn.

16. The organic electroluminescent device of claim 10, wherein the metal complex compound contains Al or Zn.

17. The organic electroluminescent device of claim 11, wherein the metal complex compound contains Al or Zn.
